(19) United States
(12) Patent Application Publication
(10) Pub. No.: US 2013/0105511 A1
(43) Pub. Date: May 2, 2013

(54) GOWN DISPENSING SYSTEMS AND GOWN CONFIGURATIONS THEREFOR

(71) Applicant: Joseph A. Graneto, III, St. Charles, MO (US)

(72) Inventor: Joseph A. Graneto, III, St. Charles, MO (US)

(21) Appl. No.: 13/660,787

(22) Filed: Oct. 25, 2012

Related U.S. Application Data
(60) Provisional application No. 61/551,698, filed on Oct. 26, 2011.
(60) Provisional application No. 61/595,533, filed on Feb. 6, 2012.
(60) Provisional application No. 61/624,770, filed on Apr. 16, 2012.

(51) Int. Cl. A47F 1/08; B31F 1/00

(52) U.S. Cl. CPC A47F 1/08; B31F 1/0006
USPC 221/303; 493/405

(57) ABSTRACT

A dispensing system for dispensing gowns generally includes a front member and a back member defining an enclosure for holding multiple folded gowns. The folded gowns each comprise a unique folding pattern, where the folding pattern of each gown is configured to provide a user access to a neck and shoulder portion of the gown after unfolding a single fold of the folded the gown. The front member of the system comprises an opening configured to facilitate removal of a single one of the gowns at a time from the enclosure through the opening. The system may also include an angled portion configured to support the gowns in the enclosure at an angle relative to a horizontal plane when the system is coupled to a vertical surface. As such, the system may have a depth dimension that is less than a depth dimension of the gowns in the system.

### CROSS-REFERENCE TO RELATED APPLICATIONS

This application claims the benefit of, and priority to, U.S. Provisional Patent Application Ser. No. 61/551,698 (filed Oct. 26, 2011), U.S. Provisional Patent Application Ser. No. 61/595,533 (filed Feb. 6, 2012), and U.S. Provisional Patent Application Ser. No. 61/624,770 (filed Apr. 16, 2012). The entire disclosures of all of the above applications are incorporated herein by reference.

### FIELD

The present disclosure generally relates to dispensing of medical gowns and, more specifically, to cartridge systems for the dispensing of medical gowns which is useful, for example, in medical office and hospital environments and to related gown configurations for use with such cartridge systems.

### BACKGROUND

This section provides background information related to the present disclosure which is not necessarily prior art.

Today's medical office and hospital environments include an extraordinary amount of personal protection equipment including, but not limited to, personal protection gowns. Personal protection gowns are often referred to herein as disposable medical gowns. There are some traditional dispensers for such gowns. Such dispensers are typically filled through the installation of individual gowns into the dispensing mechanisms, such that users can retrieve an individual gown when needed. The gowns in the dispensing mechanisms may come into contact with one or more persons as the individual gowns are transferred from a bulk storage unit into the dispenser.

### SUMMARY

This section provides a general summary of the disclosure, and is not a comprehensive disclosure of its full scope or all of its features.

Example embodiments of the present disclosure generally relate to dispensing systems for gowns. In one aspect of the present disclosure, a gown dispensing system generally includes a front member and a back member defining an enclosure for holding multiple folded gowns. The folded gowns each comprise a folding pattern, where the folding pattern of each gown is configured to provide a user access to a neck and shoulder portion of the gown after unfolding a single fold of the folded the gown. The front member comprises an opening configured to facilitate removal of a single gown at a time from the enclosure through the opening by the user.

In another aspect of the present disclosure, a gown dispensing system generally includes a front member and a back member defining an enclosure for holding gowns, and an angled portion configured to support the gowns in the enclosure at an angle relative to a horizontal plane when the gown dispensing system is coupled to a vertical surface. The front member comprises an opening configured to facilitate removal of a single gown at a time from the enclosure through the opening by a user. In some aspects of the present disclosure, the angled portion is formed as part of the front member. And, in some aspects of the present disclosure, the opening is formed in the angled portion.

In another aspect of the present disclosure, a gown dispensing system generally includes a container configured to hold multiple folded gowns and a bracket having flanges configured to receive the container into the bracket between the flanges. The container includes an access location for selectively opening the container so that individual ones of the gowns may be extracted from the container. The bracket is configured to hold the container between the flanges such that the access location is accessible to a user for selectively opening the container to allow for extraction of the gowns from the container. And, the bracket is also configured to allow for removal of the container from the bracket while retaining the folded gowns in the bracket as they slide out of the container at the access location as the container is removed from the bracket. In some aspects of the present disclosure, the gown dispensing system includes multiple folded gowns configured to be held in the container, wherein each gown comprises a folding pattern configured to provide a user access to a neck and shoulder portion of the gown after unfolding a single fold of the folded the gown.

In another aspect of the present disclosure, a gown dispensing fixture for holding a plurality of disposable gowns generally includes a back member and a front member coupled to the back member. The back member and the front member define a clamshell enclosure. The front member includes an opening formed therein for removal of a single gown at a time therethrough by a user and an angled member extending from the front member to the back member. The angled member is configured to position the plurality of disposable gowns at an angled position relative to the back member.

Example embodiments of the present disclosure also generally relate to methods of configuring (e.g., folding, etc.) gowns for removal from dispensing systems. In one aspect of the present disclosure, a method for folding a gown for use in a gown dispensing system generally includes folding a left arm portion over a back of the gown; folding a left portion of the gown, comprising about a third of the gown, across a center portion of the back of the gown, with a left tie of the gown extending onto a right arm portion of the gown; folding the left tie back onto the center portion of the gown; folding the right arm portion over the back of the gown; folding a right tie and a portion of the gown that extends downward from the right tie towards the center portion of the gown; folding a right portion of the gown, comprising about a third of the gown, over the center potion, resulting in a substantially rectangular shape for the partially folded gown; folding over a bottom of the gown an amount equal to about twice the final folded depth of the gown to define a folded bottom portion of the gown; folding the folded bottom portion of the gown in half, and then further folding the folded bottom portion of the gown over itself two times; folding over a top of the gown an amount equal to about the final folded depth of the gown to define a folded top portion of the gown; and folding the folded top portion of the gown over the folded bottom portion of the gown.

In another aspect of the present disclosure, a method for folding a disposable gown for use in a gown dispensing system generally includes folding arm portions over a back of the gown to define a substantially rectangular perimeter, folding a right portion of gown and a left portion of the gown onto a center portion of the gown, the right portion, the left portion, and the center portion substantially equal in width, folding over in a single fold, from a top of the gown, a portion of the gown that is approximately equal to a final folded depth for the folded gown to define a top folded section, folding over in a plurality of folds, from a bottom of the gown, a remaining portion of the gown to define a bottom folded section, the remaining portion folded such the bottom folded section is adjacent the top folded section and approximately equal to a final folded depth for the folded gown, and folding the top folded section onto the bottom folded section.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustrating a process for configuring a gown according to an example embodiment of the present disclosure;

FIG. 2 is a schematic illustrating, in plan view, example steps for configuring the gown in accordance with the process of FIG. 1;

FIG. 3 is a schematic further illustrating, in elevation view, steps 7-12 of FIG. 2;

FIG. 4 is a front perspective view of a gown dispensing system according to an example embodiment of the present disclosure;

FIG. 5 is a rear perspective view of the gown dispensing system of FIG. 4;

FIG. 6 is a front perspective view of a gown dispensing system according to another example embodiment of the present disclosure;

FIG. 7 is a front elevation view of a bracket of the gown dispensing system of FIG. 6 configured for use in mounting the gown dispensing system to a desired surface;

FIG. 8 is a front perspective view of a gown dispensing system according to another example embodiment of the present disclosure;

FIG. 9 is a front perspective view of a gown dispensing system according to still another example embodiment of the present disclosure;

FIG. 10 is a rear perspective view of the gown dispensing system of FIG. 9 illustrating a bracket of the gown dispensing system configured for use in mounting the gown dispensing system to a desired surface;

FIG. 11 is a front perspective view of a gown dispensing system according to another example embodiment of the present disclosure;

FIG. 12 is a front elevation view of a gown dispensing system according to still another example embodiment of the present disclosure;

FIG. 13 is a front perspective view of a gown dispensing system according to another example embodiment of the present disclosure;

FIG. 14 is a front elevation view of a gown dispensing system according to another example embodiment of the present disclosure;

FIG. 15 is a side perspective view of the gown dispensing system of FIG. 15;

FIG. 16 is a bottom perspective view of the gown dispensing system of FIG. 15;

FIG. 17 is a front elevation view of the gown dispensing system of FIG. 15 shown coupled to a personal protection equipment (PPE) dispenser;

FIG. 18 is a side perspective view of the gown dispensing system of FIG. 17;

FIG. 19 is a front elevation view of a personal protection equipment dispenser according to an example embodiment of the present disclosure;

FIG. 20 is a front elevation view of the personal protection equipment dispenser of FIG. 19 with a gown dispensing system of the present disclosure should coupled to the personal protection equipment dispenser;

FIG. 21 is a perspective view of a gown dispensing system according to another example embodiment of the present disclosure;

FIG. 22 is a perspective view of the gown dispensing system of FIG. 21 shown coupled to a personal protection equipment dispenser;

FIG. 23 is a perspective view of a gown dispensing system according to still another example embodiment of the present disclosure;

FIG. 24 is a front elevation view of the gown dispensing system of FIG. 23;

FIG. 25 is a side elevation view of the gown dispensing system of FIG. 23;

FIG. 26 is a bottom plan view of the gown dispensing system of FIG. 23;

FIG. 27 is a perspective view of a gown dispensing system according to still another example embodiment of the present disclosure;

FIG. 28 is a front elevation view of the gown dispensing system of FIG. 27;

FIG. 29 is a side elevation view of the gown dispensing system of FIG. 27;

FIG. 30 is a bottom plan view of the gown dispensing system of FIG. 27;

FIG. 31 is a perspective view of a personal protection equipment dispenser according to an example embodiment of the present disclosure;

FIG. 32 is a bottom view of a gown dispensing system coupled to the personal protection equipment dispenser of FIG. 31;

FIG. 33 is a perspective view of a glove dispensing system coupled to the personal protection equipment dispense of FIG. 31;

FIG. 34 is an exploded elevation view of a gown dispensing system according to another example embodiment of the present disclosure;

FIG. 35 is an exploded perspective view of a bag of gowns of the gown dispensing system of FIG. 34; and

FIG. 36 is a front elevation view of the gown dispensing system of FIG. 34.

Corresponding reference numerals indicate corresponding parts throughout the several views of the drawings.

### DETAILED DESCRIPTION

Example embodiments of the present disclosure generally relate to dispensing systems (e.g., gown dispensing systems, etc.) and to gowns (e.g., disposable gowns, medical gowns, personal protection gowns, etc.). The dispensing systems are configured for holding multiple gowns and for dispensing the gowns. As such, the dispensing systems can be positioned at desired locations for supplying the gowns. The dispensing systems provide access to the multiple individual gowns in a single system, without requiring each gown to be individually wrapped. Further, the gowns can be individually dispensed with users handling only the individual gown being dispensed; the gowns are not handled by users until they are extracted.

In some aspects of the present disclosure, the dispensing systems are configured so that only one gown is extracted from the dispensing systems at a time. In some aspects of the present disclosure, the gowns are configured (e.g., folded, etc.) to help ensure that only one gown is extracted from the dispensing systems at a time. And in some aspects of the present disclosure, the gowns are also (or alternatively) configured so that upon extraction from a dispensing system, the gowns are easily usable (e.g., easily unfolded for wearing, etc.).

In some aspects of the present disclosure, the dispensing systems are configured to have depth dimensions that are about equal to or less than depth dimensions of the gowns being held in the dispensing systems. For example, in some aspects of the present disclosure the dispensing systems include front and back members configured to hold gowns in the dispensing systems at desired angles relative to the front and/or back members. In so doing, the dispensing systems can be configured to have desired depth dimensions that are generally less than depth dimensions of the gowns being held in the dispensing systems. In turn, this may be used to minimize the depth dimensions of the dispensing systems (e.g., minimize distances the dispensing assemblies extend outward from walls, etc.).

Example embodiments will now be described more fully with reference to the accompanying drawings.

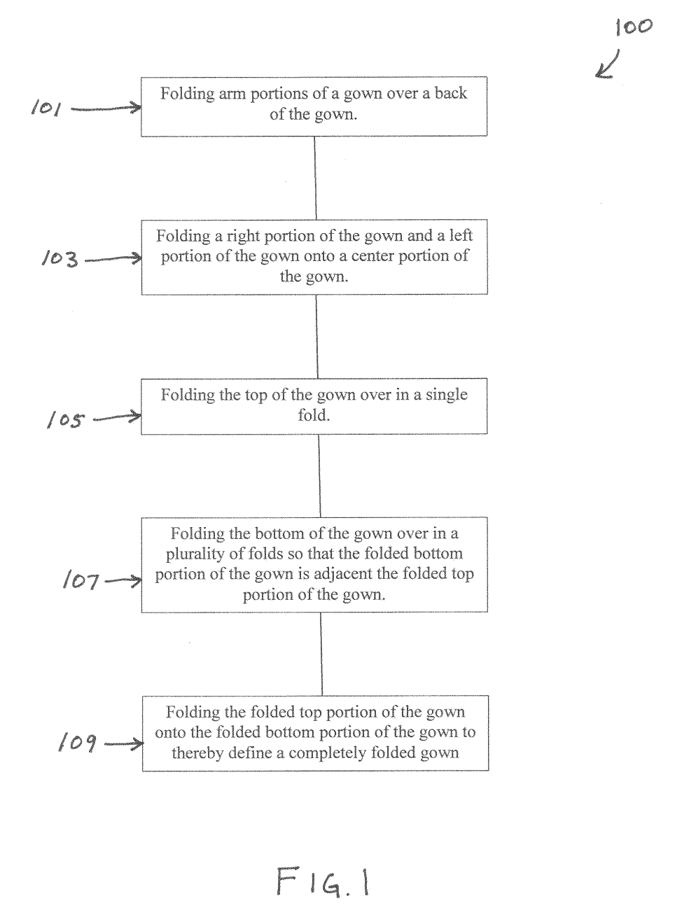

FIGS. 1-3 illustrate a process 100 of configuring (e.g., folding, etc.) a gown 102 (e.g., an over-the-head disposable gown, etc.) according to an example embodiment of the present disclosure. The configured gown 102 may be used with a dispensing system (e.g., a gown dispensing system, a dispensing system of the present disclosure, other desired dispensing systems, etc.). As discussed herein, configuration of the gown 102 within the dispensing system is important. The example process 100 provides for configuring the gown 102 to help ensure that, when located within a dispensing system with other similarly configured gowns, only the one intended gown 102 is extracted from the dispensing system at a time without inadvertently extracting other adjacent gowns (e.g., regardless of size, shape, etc. of a dispensing opening of the gown dispensing system, etc.). In addition, the example process 100 provides for configuring the gown 102 to help minimize user contact with the gown 102 (and adjacent gowns in a dispensing system) when extracting the gown 102 from a dispensing system and when preparing the gown 102 to be worn, thereby helping to maintain cleanliness, sterility, etc. of the gown 102 and minimizing contamination.

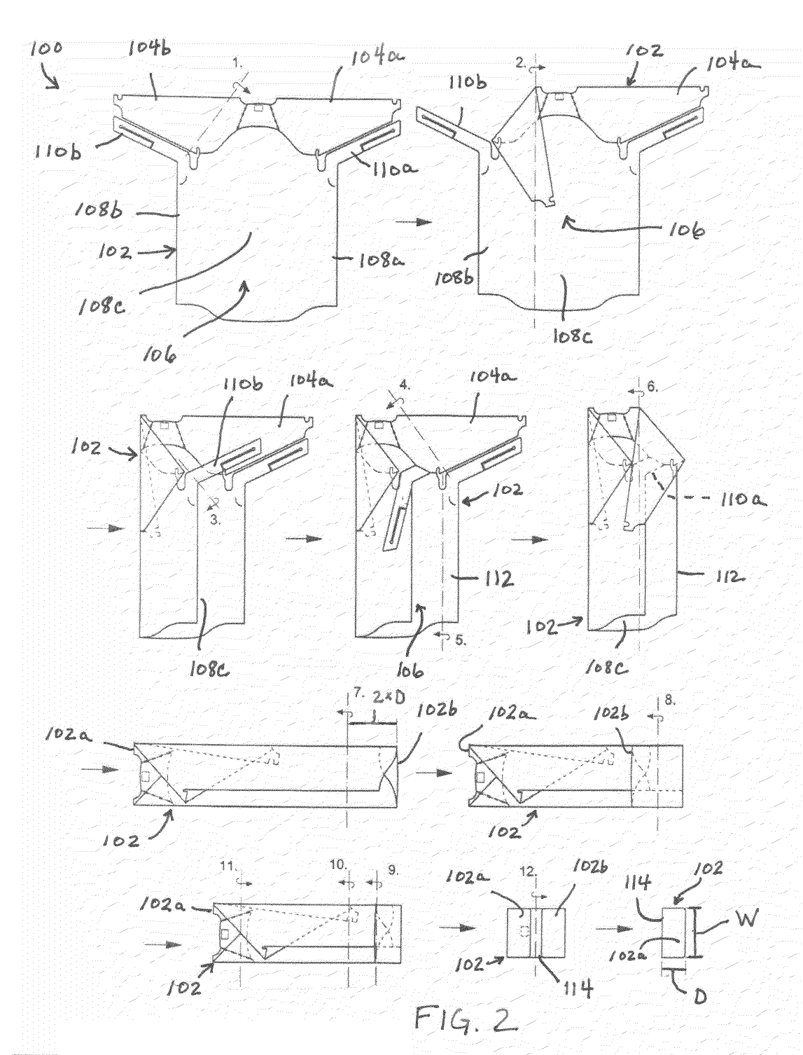

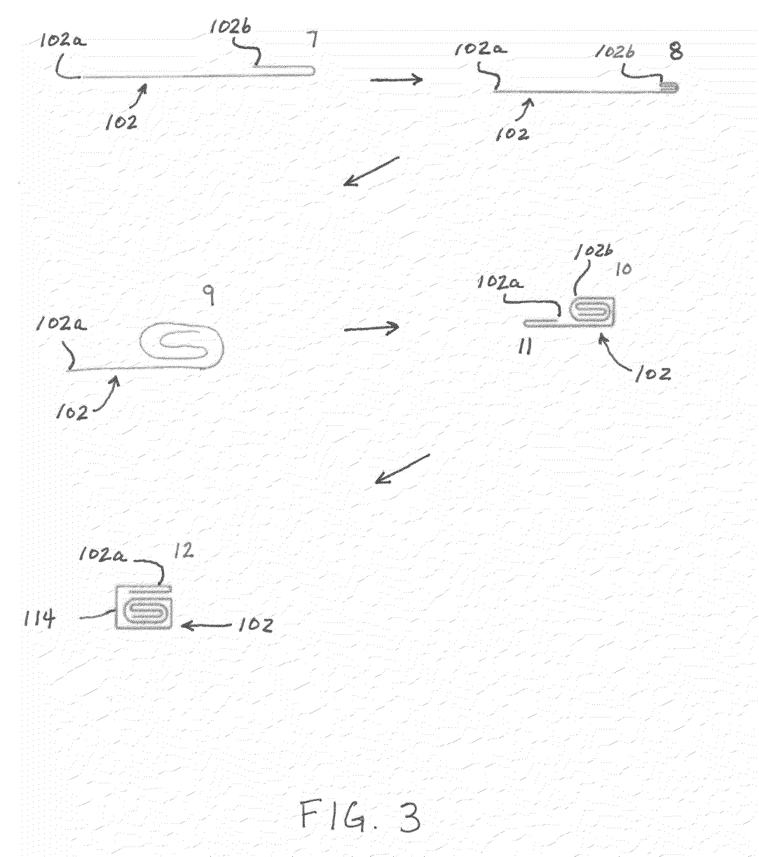

As shown in FIG. 1, the example process 100 generally includes an operation 101 of folding arm portions 104a and 104b of the gown 102 (FIGS. 2 and 3) over a back 106 of the gown 102, and an operation 103 of folding a right portion 108a of the gown 102 and a left portion 108b of the gown 102 onto a center portion 108c of the gown 102 (e.g., with the right portion 108a, the left portion 108b, and the center portion 108c of the gown 102 being substantially equal in width, etc.). Here, the resulting intermediately folded gown 102 defines a substantially rectangular perimeter, with a top 102a and a bottom 102b of the gown 102 being generally identifiable. Next, the example process 100 generally includes an operation 105 of folding the top 102a of the gown 102 over in a single fold (toward the bottom 102b of the gown 102), and an operation 107 of folding the bottom 102b of the gown 102 over in a plurality of folds (toward the top 102a of the gown 102) so that a folded bottom portion of the gown 102 is adjacent a folded top portion of the gown 102. And then, the example process 100 generally includes an operation 109 of further folding the folded top portion of the gown 102 onto the folded bottom portion of the gown 102 to thereby define a completely folded gown 102 in accordance with the present disclosure.

FIGS. 2 and 3 illustrate example steps (without limitation) for folding the gown 102 in accordance with the process 100 of the illustrated embodiment. In the figures, the folding steps are generally indicated by broken lines and arrows indicated general directions for folding.

At step 1, a left arm portion 104b of the gown 102 (as viewed in FIG. 2) is folded over the back of the gown 102. At step 2, the left portion 108b of the gown 102 (e.g., about a third of the gown 102, etc.) is folded across the center portion 108c of the back 106 of the gown 102, with a left tie 110b of the gown 102 then extending onto a right arm portion 104a of the gown 102 (see the resulting configuration of the gown 102 in step 3). At step 3, the left tie 110b is folded back onto the center portion 108c of the gown 102. At step 4, the right arm portion 104a of the gown 102 is folded over the back 106 of the gown 102. At step 5, a right tie 110a of the gown 102, and a portion 112 of the gown 102 that extends downward from the right tie 110a, are folded over toward the center portion 108c of the gown 102. And at step 6, the right arm portion 104a of the gown 102 is folded over the center portion 108c of the gown 102. At this stage of the process 100, the gown 102 is folded to a substantially rectangular shape (see the resulting configuration of the gown 102 in step 7).

At steps 7-10, the bottom 102b of the gown 102 is folded over multiple times (generally defining the folded bottom portion of the gown 102). For example, at step 7 the bottom 102b of the gown 102 is folded such that about twice the final desired folded depth D of the gown 102 (e.g., about ten inches, etc.) is folded over toward the top 102a of the gown 102, and at step 8 the bottom 102b of the gown 102 is further folded such that about one-half of the folded amount of the gown 102 from step 7 is folded over again toward the top 102a of the gown 102. Here, the folded bottom portion of the gown 102 now defines a depth that is about equal to the final desired folded depth D of the gown 102 (e.g., about five inches, etc.). At steps 9 and 10, the folded bottom portion of the gown 102 is folded over toward the top 102a of the gown 102 two more times.

At step 11, the top 102a of the gown 102 is folded over toward the bottom 102b of the gown 102 (generally defining the folded top portion of the gown 102). Specifically, the top 102a of the gown 102 is folded such that an amount of the top 102a of the gown 102 equal to the final desired folded depth D of the gown 102 (e.g., about five inches, etc.) is folded over toward the bottom 102b of the gown 102. As such, the folded top portion of the gown 102 is now adjacent the folded bottom portion of the gown 102 (see the resulting configuration of the gown 102 in step 12). And, both the folded top portion of the gown 102 and the folded bottom portion of the gown 102 have depth dimensions that are about equal to the final desired folded depth D of the completely folded gown 102 (e.g., about five inches, etc.). At step 12, the folded top portion of the gown 102 is folded over the folded bottom portion of the gown 102, with the result being the final folded gown configuration in accordance with the present disclosure (having the depth D and a width W).

When the configured gown 102 of this embodiment is installed in a dispensing system, the folded top portion of the gown 102 is generally facing upward. And, a forward fold 114 of the gown 102 is generally facing toward (e.g., is generally visible through, etc.) a dispensing opening of the dispensing system, for example, for access to a user. With that said, it can be seen that the example process 100 thus results in a gown 102 configured with a tapered forward portion that is presented to users for access through the dispensing opening of the dispensing system. In addition, the configuration of the gown 102 defines a substantially smooth, flat, planar, etc. surface on both the folded top portion and the folded bottom portion of the gown 102 which allows the gown 102 to be generally smoothly extracted from the dispensing system through the dispensing opening without portions of the gown 102 “hanging up” or becoming unfolded during the withdrawal process and without causing simultaneous extraction of adjacent gowns from the dispensing system.

The unique final configuration of the gown 102 provided by the example process 100 also allows a user to easily access the top 102a of the gown 102 (e.g., upon, after, etc. extracting the gown 102 from a dispensing system, etc.), as the top 102a of the gown 102 is generally facing upward and also as the top 102a of the gown 102 is generally subjected to only the single fold described by step 11. In addition, the gown 102 is configured in a pattern that provides a user ready access to a neck and shoulder portion at the top 102a of the gown 102 (FIG. 2) after initially extracting the gown 102 from the dispensing system and after accessing the top 102a of the gown 102 (as just described). A user will tend to unfold the step 11 fold (as this portion of the gown 102 will generally be facing upward and as less folds are defined in this area) resulting in the user holding the top 102a of the gown 102, and the remainder of the gown 102 will unfold due to gravity. As such, via the gown configuration provided by the example process 100, a user can access the neck and should portion of the gown after unfolding a single fold (the fold described by step 11). Also, the gown configuration provided by the example process 100 virtually ensures that the user will end up holding the gown 102 “right side up” and the user has access to the top 102a of the gown 102 after the unfolding of only a single fold of the folded gown 102 (which also makes putting the gown 102 on simpler than known folded gown configurations).

Further, only material from a front of the gown 102 is exposed to a user when the gown 102 is configured as described herein, as the front of the gown 102 is generally folded over the back 106 of the gown 102. As such, only material from the front of the gown 102 is contacted when extracting the gown 102 from the dispensing system. What's more, the user need only grasp the top 102a of the gown 102 and the remaining portions of the gown 102 will unfold, for example, via gravity (without user contact). This can help inhibit contamination of the gown 102, as well contamination of adjacent gowns in the dispensing system (e.g., as the gown 102 is extracted, etc.).

It should be appreciated that the various example steps described in connection with the example process 100 could be performed in different orders, with the result still being the final configuration of the gown 102 shown in FIGS. 2 and 3. In addition, the final configuration of the gown 102 could have any desired dimensions (e.g., widths, depths, thicknesses, etc.) within the scope of the present disclosure (e.g., five inches, ten inches, twelve inches, etc.). For example, in one embodiment a final configuration of the gown 102 has dimensions of about twelve inches wide by about five inches deep.

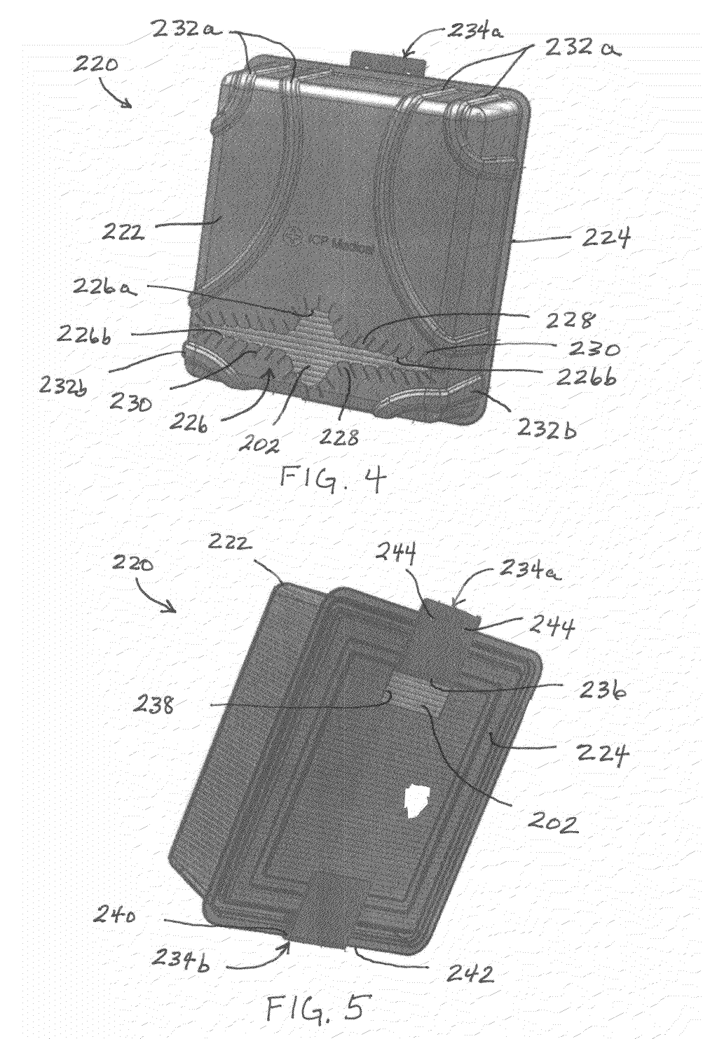

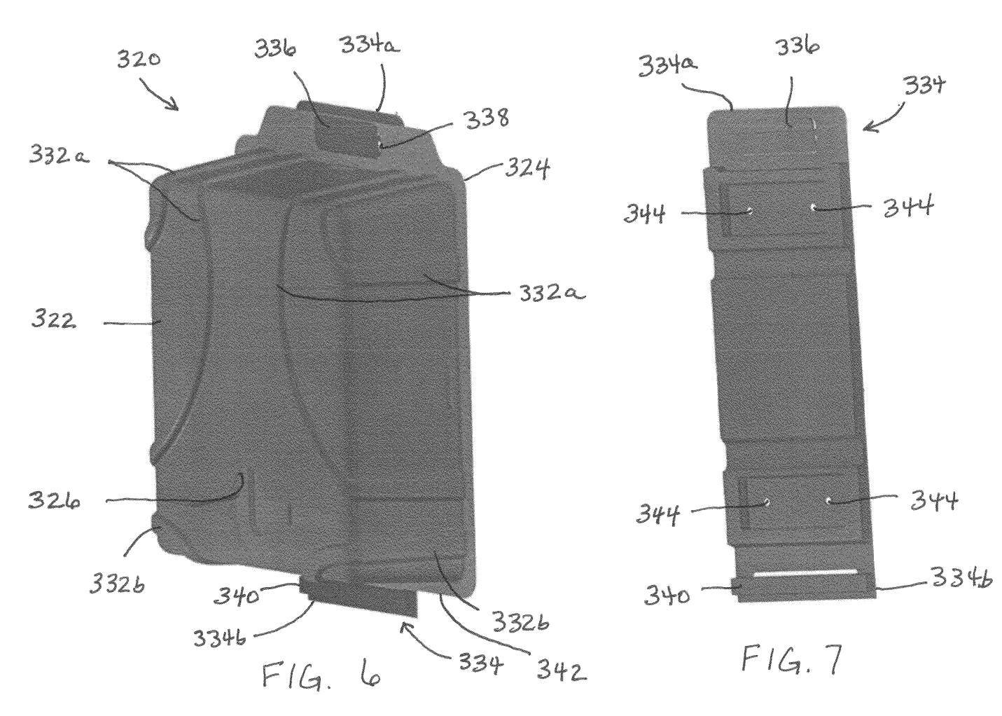

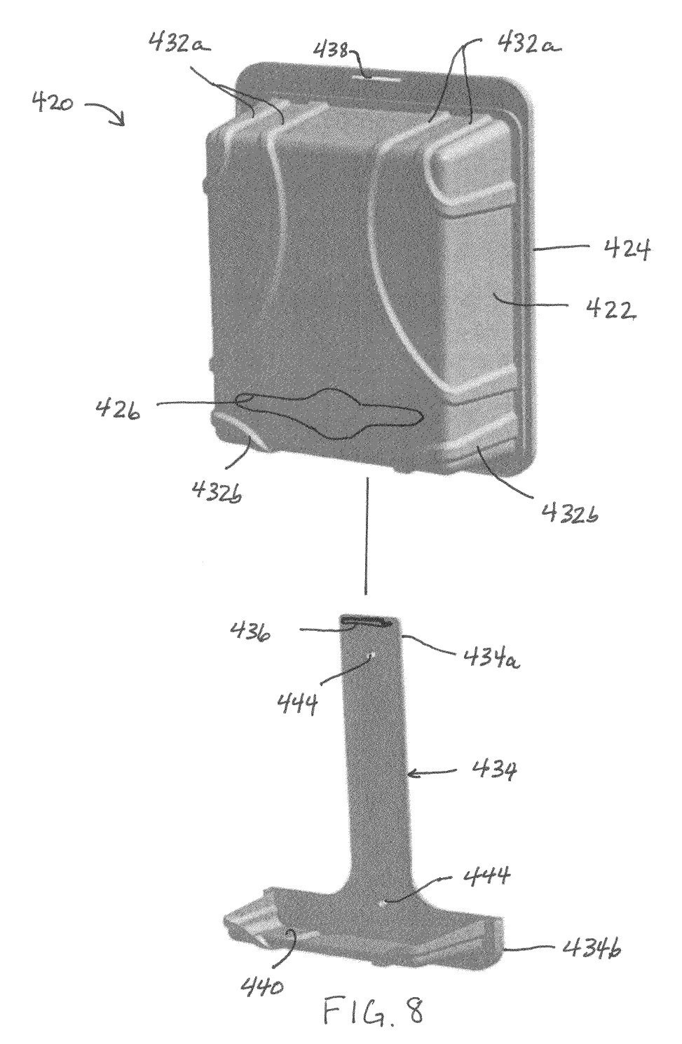

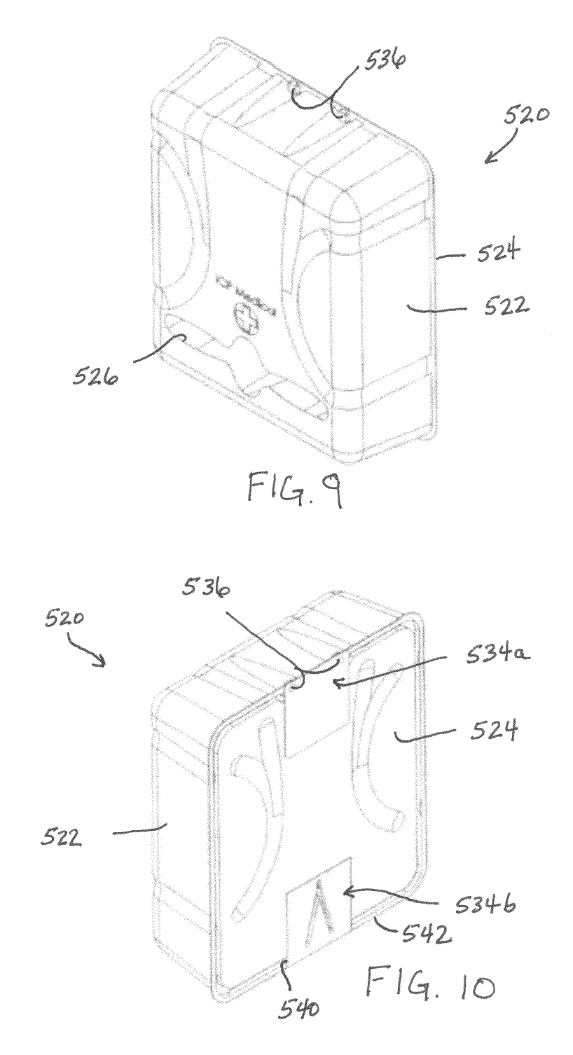

FIGS. 4 and 5 illustrate a gown dispensing system 220 (e.g., a gown dispensing cartridge, etc.) according to an example embodiment of the present disclosure. The dispensing system 220 can be used, as desired, to hold and dispense gowns 202 (e.g., to hold multiple gowns 202 and allow for dispensing one of the gowns 202 at a time, etc.). And, for example, the gowns 202 could be configured in accordance with the example process 100 of the present disclosure.

The illustrated gown dispensing system 220 generally includes a front member 222 and a back member 224 configured to be coupled together to form a container for holding gowns 202. The front member 222 and the back member 224 together can be viewed as forming a gown dispensing fixture. As an example, the gowns 202 (e.g., folded gowns, gowns configured in accordance with process 100, etc.) may be loaded between the front member 222 and the back member 224, and the front member 222 and the back member 224 can then be coupled together for holding the gowns 202. Alternatively, the gowns 202 may be loaded within the gown dispensing system 220 by any suitable process.

The front member 222 of the gown dispensing system 220 includes a dispensing opening 226, generally in the form of a slot, through which the gowns 202 can be extracted for use. A substantially circular center portion 226a of the dispensing opening 226 has a larger overall diameter than is associated with slots 226b of the dispensing opening 226 (e.g., a generally vertical dimension of the center portion 226a is greater than a generally vertical dimension of the slots 226b, etc.), which extend from either side of the center portion 226a. The center portion 226a and slots 226b of the dispensing opening 226 are configured with a plurality of fingers 228 separated by narrow indentations 230 therebetween. The fingers 228 and the indentations 230 provide an amount of flexibility (e.g., the fingers 228 are resiliently flexible, etc.) to the configuration for an amount of ease of use for the user. The center portion 226a is enlarged so that a person may reach into the gown dispensing system 220 to extract one of the gowns 202. And, the slots 226b (along with the fingers 228 and the indentations 230) help to ensure that only one gown 202 is extracted at a time. As such, in the illustrated embodiment, the general contours of the dispensing opening 226 operate to help ensure that only one gown 202 is extracted through dispensing opening 226 at a time. And further, when the gowns 202 are configured in accordance with the example process 100 of the present disclosure, the uniquely configured gowns 202 further help ensure that only one gown 202 is extracted through the dispensing opening 226 at a time and, further, that each extracted gown 202 is configured to unfold in such a way that it is fairly easy for a user to put on. In other example embodiments, dispensing systems may include dispensing openings having other configurations suitable for use in helping to ensure that only single gowns are extracted from the dispensing systems through the dispensing openings.

In the illustrated embodiment, the front member 222 and the back member 224 of the gown dispensing system 220 are separately formed and are joined together once the gowns 202 are placed therebetween. The configuration of the front member 222 and the back member 224 may also be referred to as a clamshell configuration (as well as to a dispensing assembly fixture), with the front member 222 referred to as a tub (as it is the member into which the gowns 202 are placed prior to joining the front member 222 and the back member 224). The front member 222 and the back member 224 may be formed from any suitable material within the scope of the present disclosure (e.g., plastic, composite material, etc.). In addition, the front member 222 and the back member 224 may be joined together in a number of ways including (but not limited to), for example, heat welding, spot welding, ultrasonic welding, adhesive, snap fit configurations, etc.

As shown in FIG. 4, the front member 222 of the gown dispensing system 220 is molded to include a plurality of strengthening ribs 232a and 232b. A first set of ribs 232a extend along an upper portion of the front member 222. And, a second set of ribs 232b extend along a lower portion of the front member 222. With that said, other configurations (e.g., shapes, sizes, numbers, etc.) of the strengthening ribs 232a and 232b are contemplated within the scope of the present disclosure.

As shown in FIG. 5, brackets 234a and 234b are coupled to the back member 224 14 of the gown dispensing system 220. The brackets 234a and 234b can be used to mount the gown dispensing system 220 to a desired surface, for example, a wall, a door, a bracketing system, etc. In the illustrated embodiment, the brackets 234a and 234b each have a generally U-shape. A hook portion 236 of the upper bracket 234a is configured to engage the back member 224 of the gown dispensing system 220 via an opening 238 in the back member 224. And, a hook portion 240 of the lower bracket 234b is configured to engage a lip 242 of the gown dispensing system 220 formed by the mating of the front member 222 and the back member 224. And, holes 244 (e.g., one or more holes, etc.) are formed in each of the brackets 234a and 234b for use in coupling the gown dispensing system 220 to the desired surface. In other example embodiments, gown dispensing systems may include brackets with adhesive or other suitable material or structure for use in coupling the brackets to the gown dispensing systems and/or for use in mounting the gown dispensing systems (via the brackets) to desired surfaces. In other example embodiments, gown dispensing systems may include brackets integrally formed with front and/or back members of the gown dispensing systems.

The opening 238 in the back member 224 of the gown dispensing system 220 can be formed as desired within the scope of the present disclosure. For example, the opening 238 may be created through the removal of a cover attached over the opening 238 with an adhesive, for example, upon deployment of the gown dispensing system 220, etc. Alternatively, the opening 238 may be defined through perforations in the back member 224 which allow for a portion of the back member 224 to be removed, thereby forming the opening 238. Still further, the upper bracket 234a itself may comprise a perforated portion that is removed from the back member 224 to thereby define the opening 238. Here, for example, the back member 224 may be molded with perforations, around three sides of the opening 238, such that a flap is defined that can then be folded out (to define the opening 238) and used as the bracket 234a.

While not shown in FIG. 4 or 5, the dispensing opening 226 of the gown dispensing system 220 may be initially covered with a removable layer that is attached about the opening 226, for example, with an adhesive. Such covering of the dispensing opening 226 can help protect the integrity, cleanliness, etc. of the gowns 202 in the dispensing system 220 during shipping, deployment, storage, etc. In other example embodiments, dispensing systems may include dispensing openings formed by removing panels from front members of the dispensing systems. Here, the panels may be defined by perforations in the front members about perimeters of the dispensing openings, etc. In still other example embodiments, dispensing systems may be enclosed within sealed articles to thereby help maintain integrity, cleanliness, etc. of gowns in the dispensing systems.

FIGS. 6 and 7 illustrate a gown dispensing system 320 according to another example embodiment of the present disclosure. The dispensing system 320 can again be used, as desired, to hold and dispense gowns (not shown) (e.g., to hold multiple gowns and allow for dispensing one of the gowns at a time, etc.). And, for example, the gowns could be configured in accordance with the example process 100 of the present disclosure.

With that said, the gown dispensing system 320 is substantially similar to the gown dispensing system 220 described in connection with FIGS. 4 and 5. And, the description of the gown dispensing system 220 generally applies to the gown dispensing system 320 of this embodiment. For example, the gown dispensing system 320 generally includes a front member 322 and a back member 324 that are coupled together to form a container for gowns. The front member 322 includes a dispensing opening 326, generally in the form of a slot, through which the gowns can be extracted for use. The front member 322 is also molded to include strengthening ribs 332a and 332b.

In this example embodiment, however, the gown dispensing system 320 includes a bracket 334 for use in coupling the gown dispensing system 320 to a desired surface, where the bracket 334 is different from the brackets 234a and 234b of the gown dispensing system 220. The bracket 334 includes an upper portion 334a configured to engage an upper portion of the gown dispensing system 320 and a lower portion 334b configured to engage a lower portion of the gown dispensing system 320 (for coupling the bracket 334 to the gown dispensing system 320). A hooking member 336, positioned toward the upper portion 334a of the bracket 334, is configured to engage (e.g., fit within, etc.) an opening 338 positioned adjacent the upper portion of the gown dispensing system 320. The illustrated hooking member 336 extends substantially perpendicular from the upper portion 334a of the bracket 334 and includes a generally L-shape for fitting (and securing) within the opening 338. A slot member 340, positioned toward the lower portion 334b of the bracket 334, is configured to engage a lip 342 of the gown dispensing system 320 formed by the mating of the front member 322 and the back member 324. The slot member 340 extends substantially perpendicular from the lower portion 334b of the bracket 334 and generally defines a channel for receiving the lip 342. And, holes 344 (e.g., one or more holes, etc.) are formed in the upper and lower portions 334a and 334b of the bracket 334 for use in coupling the gown dispensing system 320 101 to the desired surface.

In other example embodiments, dispensing systems may include openings located in any suitable positions (e.g., toward centers of the dispensing systems, toward bottoms of the dispensing systems, etc.) for use in coupling brackets to the dispensing systems. What's more, it should be appreciated that the bracket 334 of the dispensing system 320 of this example embodiment could be used, as desired, with any gown dispensing system of the present disclosure.

FIG. 8 illustrates a gown dispensing system 420 according to another example embodiment of the present disclosure. The dispensing system 420 can again be used, as desired, to hold and dispense gowns (not shown) (e.g., to hold multiple gowns and allow for dispensing one of the gowns at a time, etc.). And, for example, the gowns could be configured in accordance with the example process 100 of the present disclosure.

The gown dispensing system 420 is again substantially similar to the gown dispensing system 220 described in connection with FIGS. 4 and 5. And, the description of the gown dispensing system 220 generally applies to the gown dispensing system 420 of this embodiment. For example, the gown dispensing system 420 generally includes a front member 422 and a back member 424 that are coupled together to form a container for gowns. The front member 422 includes a dispensing opening 426, generally in the form of a slot, through which the gowns can be extracted for use. The front member 422 is also molded to include strengthening ribs 432a and 432b.

In this example embodiment, however, the gown dispensing system 420 includes a bracket 434 for use in coupling the gown dispensing system 420 to a desired surface, where the bracket 434 is again different from the brackets 234a and 234b of the gown dispensing system 220. The bracket 434 defines a generally T-shape and includes an upper portion 434a and a lower portion 434b for coupling the bracket 434 to the gown dispensing system 420. A hooking member 436 is positioned toward the upper portion 434a of the bracket 434 and is configured to engage (e.g., fit within, etc.) an opening 438 defined adjacent an upper portion of the gown dispensing system 420. The illustrated hooking member 436 defines a generally L-shape for fitting (and securing) within the opening 438. A plateau 440 is positioned toward the lower portion 434b of the bracket 434 and is configured to receive and support a lower portion of the gown dispensing system 420. And, holes 444 (e.g., one or more holes, etc.) are formed in the bracket 434 for use in coupling the gown dispensing system 420 to the desired surface.

In other example embodiments, gown dispensing systems may include brackets having upper portions with hooking members shaped differently than described herein (e.g., with shapes other than L-shapes, etc.) and/or lower portions shaped differently than described herein (e.g., with plateaus having shapes other than illustrated herein, etc.). In addition, it should be appreciated that the bracket 434 of the dispensing system 420 of this example embodiment could be used, as desired, with any gown dispensing system of the present disclosure.

FIGS. 9 and 10 illustrate a gown dispensing system 520 according to another example embodiment of the present disclosure. The dispensing system 520 can again be used, as desired, to hold and dispense gowns (not shown) (e.g., to hold multiple gowns and allow for dispensing one of the gowns at a time, etc.). And, for example, the gowns could be configured in accordance with the example process 100 of the present disclosure.

The gown dispensing system 520 of this example embodiment is again substantially similar to the gown dispensing system 220 described in connection with FIGS. 4 and 5. And, the description of the gown dispensing system 220 generally applies to the gown dispensing system 520 of this embodiment. For example, the gown dispensing system 520 generally includes a front member 522 and a back member 524 that are coupled together to form a container for gowns. The front member 522 includes a dispensing opening 526, generally in the form of a slot, through which the gowns can be extracted for use.

In this example embodiment, the gown dispensing system 520 includes upper and lower brackets 534a and 534b for use in coupling the gown dispensing system 520 to a desired surface. The upper bracket 534a is generally flat and includes fasteners 536 for coupling the bracket 534a to the dispensing system 520 (and/or for coupling the bracket 534a to the desired surface). The lower bracket 534b is configured to engage a lip 542 of the gown dispensing system 520 formed by the mating of the front member 522 and the back member 524 for coupling the lower bracket 534b to the gown dispensing system 520. The lower bracket defines a generally V-shape opening 540 configured to receive a corresponding V-shape protrusion of a mating portion of the bracket 534b coupled to the desired mounting surface (e.g., via fasteners, adhesives, etc.).

In other example embodiments, gown dispensing systems may include brackets having shapes other than described herein (e.g., with shapes other than V-shapes, etc.). In addition, it should be appreciated that the brackets 534a and 534b of the dispensing system 520 of this example embodiment could be used, as desired, with any gown dispensing system of the present disclosure.

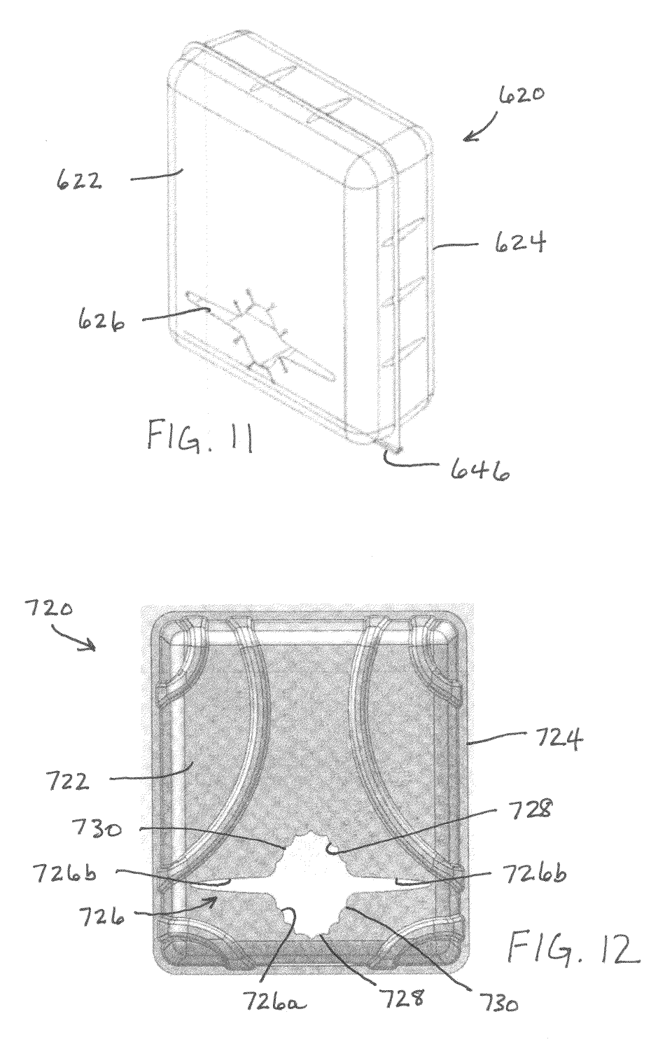

FIG. 11 illustrates a gown dispensing system 620 according to another example embodiment of the present disclosure. The dispensing system 620 can again be used, as desired, to hold and dispense gowns (not shown) (e.g., to hold multiple gowns and allow for dispensing one of the gowns at a time, etc.). And, for example, the gowns could be configured in accordance with the example process 100 of the present disclosure.

The gown dispensing system 620 of this example embodiment is again substantially similar to the gown dispensing system 220 described in connection with FIGS. 4 and 5. And, the description of the gown dispensing system 220 generally applies to the gown dispensing system 620 of this embodiment. For example, the gown dispensing system 620 generally includes a front member 622 and a back member 624 that are coupled together to form a container for gowns. The front member 622 includes a dispensing opening 626, generally in the form of a slot, through which the gowns can be extracted for use.

In this example embodiment, the front member 622 and the back member 624 of the gown dispensing system 620 are coupled together by a hinge 646. As such, to close the gown dispensing system 620 of this example embodiment (e.g., after filling the front and/or back members 622 and/or 624 with gowns, etc.), the front and back members 622 and 624 can be pivoted relative to each other (via the hinge 646) to close the gown dispensing system 620 (e.g., and snap fit the front and back members 622 and 624 together, etc.). It should be appreciated that any gown dispensing system of the present disclosure could include a hinge (similar to hinge 646 of the gown dispensing system 620) for coupling a front member and a back member of the gown dispensing system together.

FIG. 12 illustrates a gown dispensing system 720 according to still another example embodiment of the present disclosure. The dispensing system 720 can again be used, as desired, to hold and dispense gowns (not shown) (e.g., to hold multiple gowns and allow for dispensing one of the gowns at a time, etc.). And, for example, the gowns could be configured in accordance with the example process 100 of the present disclosure.

The gown dispensing system 720 of this example embodiment is again substantially similar to the gown dispensing system 220 described in connection with FIGS. 4 and 5. And, the description of the gown dispensing system 220 generally applies to the gown dispensing system 720 of this embodiment. For example, the gown dispensing system 720 generally includes a front member 722 and a back member 724 that are coupled together to form a container for gowns. The front member 722 includes a dispensing opening 726, generally in the form of a slot, through which the gowns can be extracted for use.

In this example embodiment, the dispensing opening 726 of the gown dispensing system 720 is configured differently than the dispensing opening 226 of the gown dispensing system 220. The dispensing opening 726 here includes a substantially circular center portion 726a and slots 726b, which extend from either side of the center portion 726a. The center portion 726a of the dispensing opening 726 is configured with a plurality of fingers 728 separated by narrow indentations 730 therebetween, while the perimeters of the slots 726b of the dispensing opening 726 are generally smooth. The fingers 728 and the indentations 730 of the center portion 726a provide an amount of flexibility to the configuration for an amount of ease of use for the user. The center portion 726a is enlarged so that a person may reach into the gown dispensing system 720 to extract one of the gowns. And, the slots 726b (along with the fingers 728 and the indentations 730) help to ensure that only one gown is extracted at a time. As such, in the illustrated embodiment, the general contours of the dispensing opening 726 operate to help ensure that only one gown is extracted through dispensing opening 726 at a time.

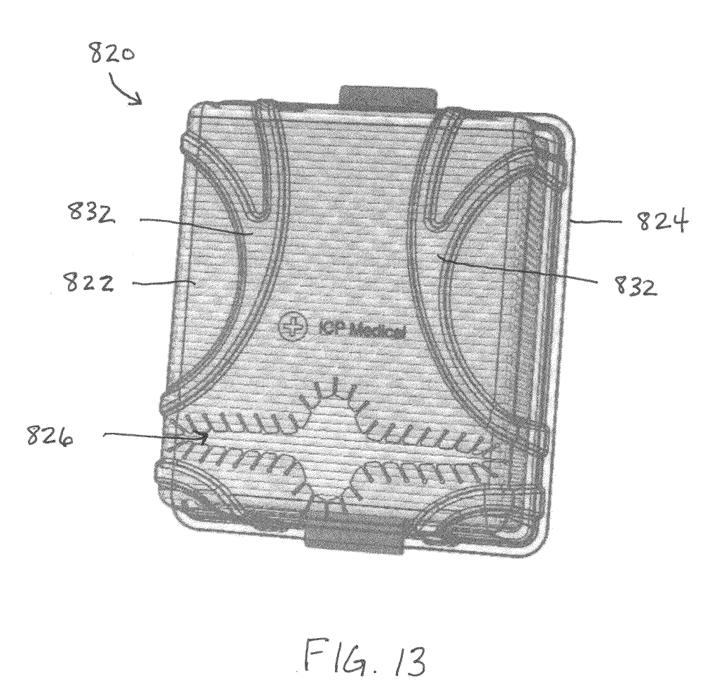

FIG. 13 illustrates a gown dispensing system 820 according to another example embodiment of the present disclosure. The dispensing system 820 can be used, as desired, to hold and dispense gowns 802 (e.g., to hold multiple gowns 802 and allow for dispensing one of the gowns 802 at a time, etc.). And, for example, the gowns 802 could be configured in accordance with the example process 100 of the present disclosure.

The gown dispensing system 820 of this example embodiment is again substantially similar to the gown dispensing system 220 described in connection with FIGS. 4 and 5. And, the description of the gown dispensing system 220 generally applies to the gown dispensing system 820 of this embodiment. For example, the gown dispensing system 820 generally includes a front member 822 and a back member 824 that are coupled together to form a container for the gowns 802. The front member 822 includes an opening 826, generally in the form of a slot, through which the gowns 802 can be extracted for use. In this example embodiment, however, the gown dispensing system 820 includes strengthening ribs 832 arranged in a different configuration than in the gown dispensing system 220.

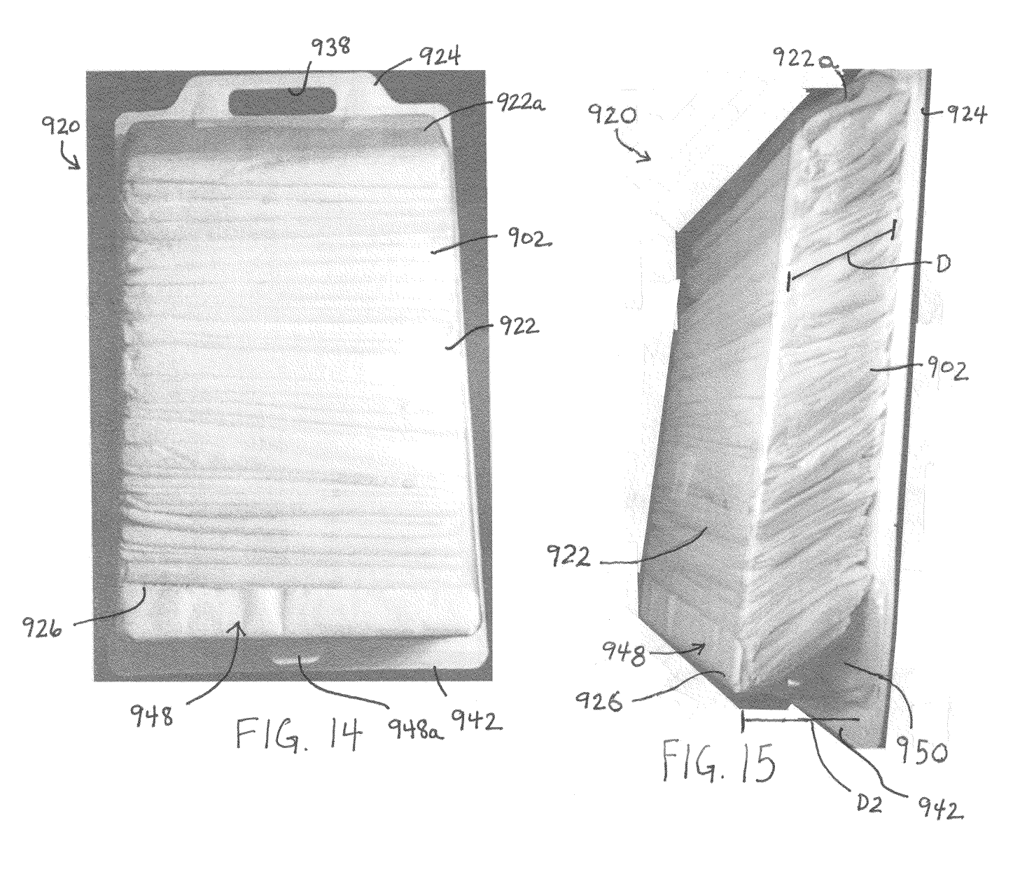

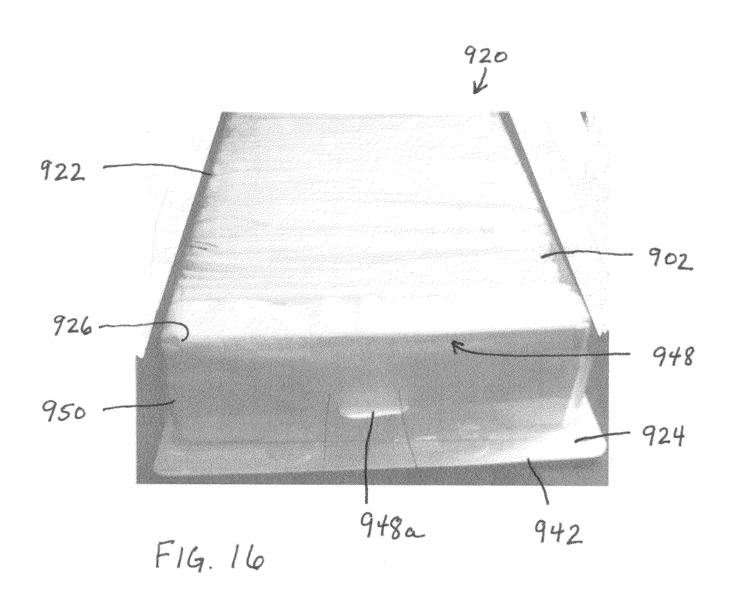

FIGS. 14-18 illustrate a gown dispensing system 920 according to another example embodiment of the present disclosure. The dispensing system 920 can be used, as desired, to hold and dispense gowns 902 (e.g., to hold multiple gowns 902 and allow for dispensing one of the gowns 902 at a time, etc.). And, for example, the gowns 902 could be configured in accordance with the example process 100 of the present disclosure.

The gown dispensing system 920 of this example embodiment generally includes a front member 922 and a back member 924 configured to be coupled together to define a gown dispensing fixture (e.g., a clamshell configuration, etc.) for holding the gowns 902. In the illustrated embodiment, the front member 922 and the back member 924 are separately formed and then are joined together after the gowns 902 are placed therebetween. With that said, the front member 922 and the back member 924 may be formed from any suitable material within the scope of the present disclosure (e.g., plastic, composite material, etc.). In addition, the front member 922 and the back member 924 may be joined together in a number of ways including (but not limited to), for example, heat welding, spot welding, ultrasonic welding, adhesive, snap fit configurations, etc.

An upper portion 922a of the front member 922 of the gown dispensing system 920 is generally angled, extending generally upwardly (at an angle) from the front member 922 toward the back member 924. With this configuration, the upper portion 922a of the front member 922 can be used to accommodate a decal, logo, sticker, etc. For example, an angle of the upper portion 922a relative to the horizontal (e.g., a horizontal plane, etc.), or alternatively, to the vertical, may be any suitable angle to allow an individual, patient, employee, visitor, passerby, etc. to view, access, read, etc. the decal, logo, sticker, etc. The angle of the upper portion 922a may be, for example, about 30 degrees, about 45 degrees, about 60 degrees, less than about 30 degrees, less than about 45 degrees, less than about 60 degrees, between about 30 and 60 degrees, between about 40 and 50 degrees, etc. And, the decal logo, sticker, etc. may be coupled to the upper portion 922a in any suitable manner, including by adhesive, pins, rivets, screws, nails, velcro, etc.

The front member 922 of the gown dispensing system 920 also includes a dispensing opening 926 formed in a bottom portion of the front member 922. The dispensing opening 926 is configured to facilitate removal of a single gown 902 at a time by a user from the gown dispensing system 920. For example, the dispensing opening 926 is formed in the shape of a slot, through which the gowns 902 can be extracted for use. Although not shown, the dispensing opening 926 could also include fingers separated by narrow indentations therebetween within the scope of the present disclosure. As such, in the illustrated embodiment, the general contours of the dispensing opening 926 operate to help ensure that only one gown 902 is extracted through dispensing opening 926 at a time. And, when the gowns 902 are configured in accordance with the example process of the present disclosure, the uniquely configured gowns 902 further help ensure that only one gown 902 is extracted through the dispensing opening 926 at a time and that each extracted gown 902 is configured to unfold in such a way that it is fairly easy for a user to put on. In other example embodiments, gown dispensing systems may include front members with openings positioned in other suitable locations on the front members, for example, in top portions, center portions, etc. of the front members.

The dispensing opening 926 of the gown dispensing system 920 is initially closed (e.g., covered, blocked, etc.) by a barrier 948 (e.g., a removable layer, etc.) after filling the gown dispensing system 920 with the gowns 902. In the illustrated embodiment, the barrier 948 includes a paper inserted within the dispensing opening 926. A tab 948a extends from the barrier 948 and through the dispensing opening 926, and is configured to allow a user to pull the tab 948a to thereby remove the barrier 948 from the dispensing opening 926. The tab 948a may be formed separately from the barrier 948 and then attached to the barrier 948 by any suitable method. Or alternatively, the tab 948a and the barrier 948 may be integrally formed as a single piece. With that said, the barrier 948 may be any suitable barrier 948 within the scope of the present disclosure that generally encloses the gowns 902 within the gown dispensing fixture 920. For example, in other example embodiments, gown dispensing systems may include barriers covering dispensing openings by adhering (via adhesive, etc.) the barrios over the opening, barriers covering dispensing openings that include shrink wrap extending over the dispensing openings, etc.

The gown dispensing assembly also includes an angled portion 950 (FIG. 15) at the front member 922 of the gown dispensing system 920, and located generally toward a bottom of the front member 922. The angled portion 950 generally extends upwardly from the front member 922 to the back member 924. The angled portion 950 is configured to position the gowns 902 in the gown dispensing system 920 at an angled position relative to the back member 924. The gowns 902 may be positioned against the angled portion 950 and at an angled position relative to the front and back members 922 and 924 (e.g., angled generally upwardly from the front member 922 to the back member 924, etc.). In other example embodiments, gown dispensing systems may include angled members positioned adjacent top portions of the systems to thereby provide angled structures in the system 920s for helping orient gowns in the systems (e.g., at an angle, etc.). In still other example embodiments, gown dispensing systems may include angled members positioned adjacent top and bottom portions of the systems to thereby provide angled structures in the systems for helping orient gowns in the systems (e.g., at an angle, etc.). In still other example embodiments, gown dispensing systems may include angled members extending in a generally downward angle from front members to back members of the systems.

The angled portion 950 of the gown dispensing system 920 may be formed of any suitable material within the scope of the present disclosure, for example, plastic, etc. Additionally, the angled portion 950 may be formed as part of the front member 922, or separately from the front member 922 and then attached to the front member 922 by any suitable method. Thus, the angled portion 950 may be separate and discrete from the front member 922 and positioned between the front member 922 and the back member 924. Alternatively, the angled portion 950 and the front member 922 may be integrally formed as a single piece. For example, the angled portion 950 may define the bottom of the front member 922. Or, the angled portion 950 and the back member 924 may be integrally formed as a single piece.

The angled portion 950 of the gown dispensing system 920 allows the distance from the back member 924 to the front member 922 (i.e., a depth D2 of the disposable gown dispensing system 920) to be generally any desired distance (e.g., a distance generally less than that in systems that do not include such angled portions, etc.). Thus, the depth D2 of the gown dispensing system 920 may be altered by increasing or decreasing an angle of the angled portion 950 relative to the back member 924 and/or the front member 922. Further, in the illustrated embodiment, the depth D2 of the gown dispensing system 920 is less than a depth D of the gowns 902 retained therein (further helping to hold the gowns 902 at an angle in the gown dispensing system 902). As an example, this feature may be beneficial for maintaining the system 920 closer to a wall to which it is coupled, avoiding getting hit by individuals, hospital beds, carts, etc., greater visually appearance, hiding/disguising the system 920 more easily, etc. Accordingly, when the gown dispensing system 920 is attached to a wall of a hospital, the depth of the gown dispensing system 920 may be maintained, if desired, within a particular minimum distance.

For example, the depth of the gown dispensing system 920 may be less than about six inches. More preferable, the depth of the gown dispensing system 920 may be less than about five inches. Even more preferable, the depth of the gown dispensing system 920 may be less than about four inches. In other embodiments, the depth of the gown dispensing system 920 may even be less than about 3.5 inches. Alternatively, the depth of the gown dispensing system 920 may be more than about six inches, between about three inches and about five inches, etc. In still other embodiments, the depth of the gown dispensing system 920 may be about 4.5 inches. In one example embodiment, a depth of the gown dispensing system 920 is less than a depth of a folded gown 902 used with the system 920 (e.g., such that the folded gown 902 is oriented at an angle within the system 920, etc.).

Additionally, the angle of the angled portion 950 of the gown dispensing system 920 relative to the horizontal (e.g., a horizontal plane, etc.), or alternatively, to the vertical, may be any suitable angle (e.g., to achieve a desired depth of the gown dispensing system 920, etc.). For example, the angle may be about 30 degrees, about 45 degrees, about 60 degrees, less than about 30 degrees, less than about 45 degrees, less than about 60 degrees, between about 30 and 60 degrees, between about 40 and 50 degrees etc.

In other example embodiments, ribs may additionally (or alternatively) be provided along sides of the front member 922 of the gown dispensing system 920 to hold the gowns 902 at a desired angle, for example any one of the angles described above. Alternatively, any other suitable feature (e.g., a structure, etc.) may be employed to hold the gowns 902 at a desired angle, for example any one of the angles described above, etc.

The gown dispensing system 920 is configured to be coupled to a desired surface for allowing access to the gowns 902. For example, the gown dispensing system 920 may be coupled to a personal protection equipment (PPE) dispenser (example configurations and further embodiments of personal protection equipment dispensers are disclosed in U.S. Pat. No. 7,246,710, which is incorporated herein by reference in its entirety). Alternatively, the gown dispensing system 920 may be coupled to a wall, etc. by screws, bolts, adhesive or any suitable attachment means. Further, the back member 924 of the gown dispensing fixture may include at least one bracket configured to allow the gown dispensing system 920 to attach to the desired surface. In some embodiments, the bracket may be an opening configured to engage a bracket, a U shaped hook, a J shaped hook, etc. of a personal protection equipment dispenser.

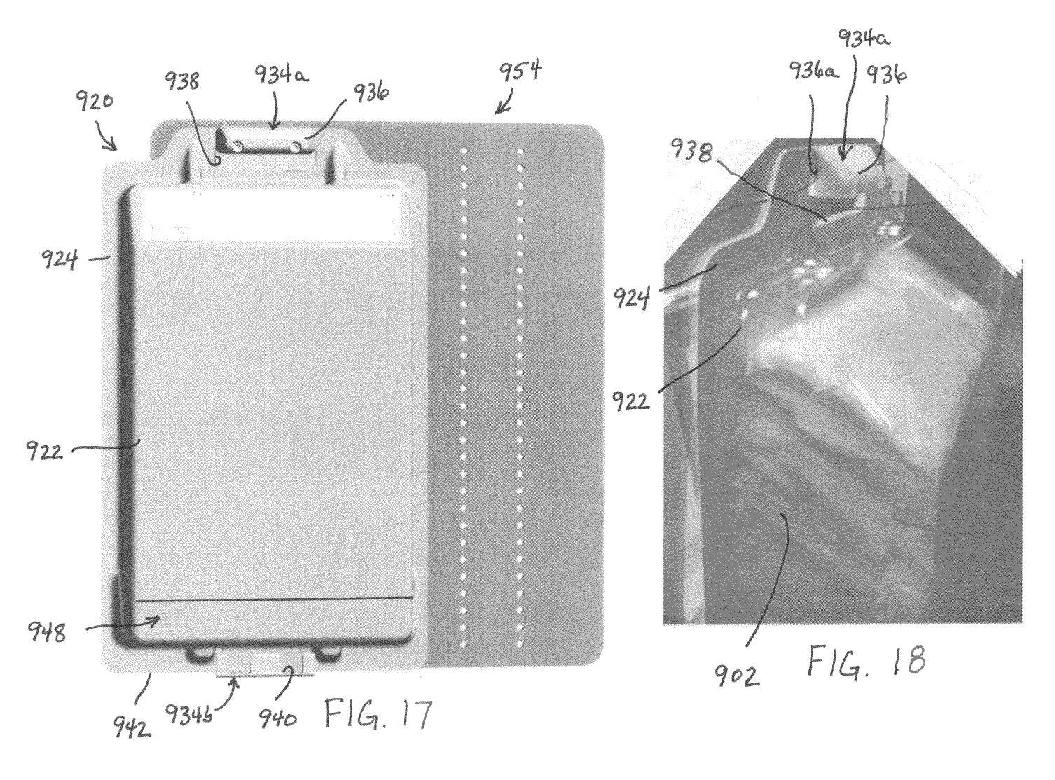

FIGS. 17 and 18 illustrate the gown dispensing system 920 coupled to a personal protection equipment dispenser 954. Upper and lower brackets 934a and 934b of the personal protection equipment dispenser 956 are used to couple the gown dispensing system 920 to the personal protection equipment dispenser 954. The brackets 934a and 934b may be attached to the personal protection equipment dispenser 954 by any suitable fasteners (e.g., screws, bolts, etc.), adhesives, other suitable attachment means, etc. The upper bracket 934a is configured to engage (and be received within) an opening 938 defined in the back member 902 of the gown dispensing system 920. Specifically, a portion 936 of the bracket 1502 extending from the personal protection equipment dispenser 954 is configured to engage and pass through the opening 938, and receive an edge of the opening into a slot 936a of the portion 936 of the upper bracket 934a. And, the lower bracket 934b is configured to engage a lip 942 of the gown dispensing system 920, and receive the lip 943 within a groove 940 of the bracket 934b. The weight of the gown dispensing system 920 may then be supported by the brackets 934a and 934b on the personal protection equipment dispenser 954.

It should be appreciated that the gown dispensing system 920 may be configured for a one time use or, alternatively, may be reused. That is, the gown dispensing system 920 may be used one time and then discarded. Or alternatively, the gown dispensing system 920 may be used, and then subsequently dismembered by separating the front member 922 and/or the back member 924 from each other allowing insertion of new gowns. This is also applicable to any other gown dispensing system of the present disclosure.

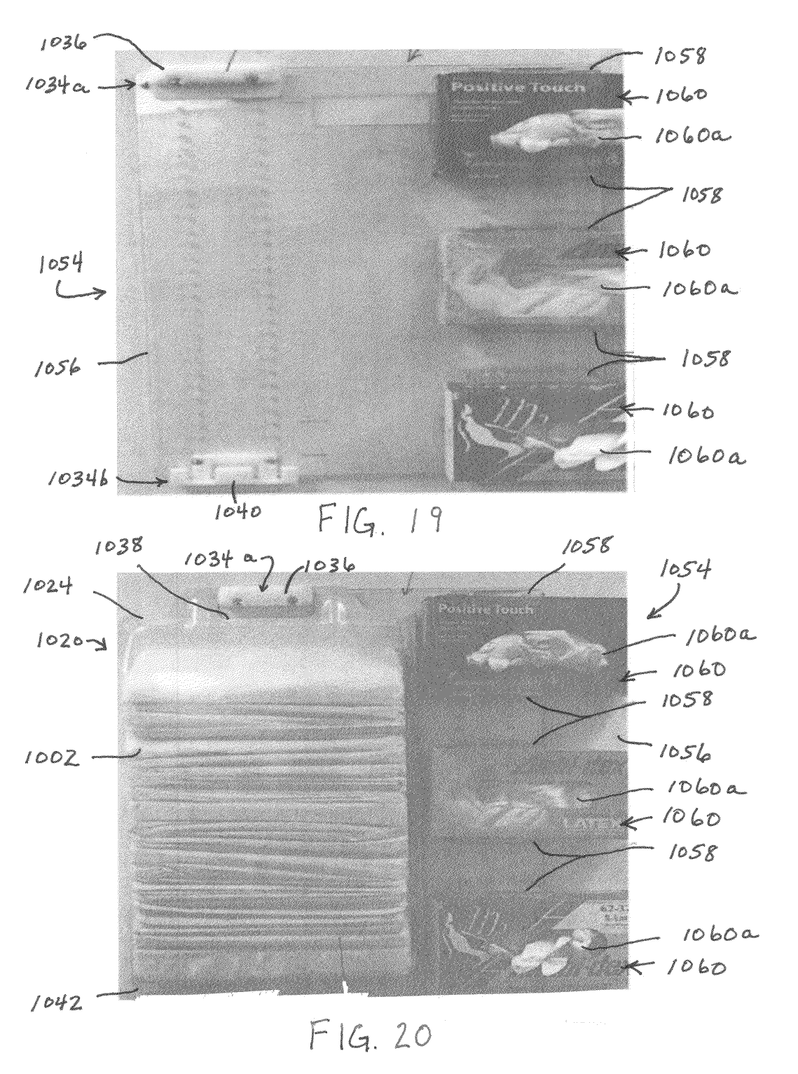

FIGS. 19 and 20 illustrate an example embodiment of a personal protection equipment (PPE) dispenser 1054, to which a gown dispensing system 1020 can be coupled. The gown dispensing system 1020 is substantially the same as the gown dispensing system 920 described in connection with FIGS. 14-18 (such that a further description of the dispensing system 1020 will not be provided).

In this example embodiment, upper and lower brackets 1034a and 1034b are coupled to a support 1056 of the personal protection equipment dispenser 1054 (e.g., via suitable fasteners (e.g., screws, bolts, etc.), adhesives, other suitable attachment means, etc.), and are used to couple the gown dispensing system 1020 to the personal protection equipment dispenser 1054. The upper bracket 1034a is configured to engage (and be received within) an opening 1038 defined in a back member 1024 of the gown dispensing system 1020. Specifically, a portion of the bracket 1034a extending from the personal protection equipment dispenser 1054 is configured to engage and pass through the opening 1038, and receive an edge of the opening into a slot 1036 of the bracket 1034a. And, a lower bracket 1034b is configured to engage a lip 1042 of the gown dispensing system 1020, and receive the lip 1042 within a groove 1040 (e.g., a segmented groove, etc.) of the bracket 1034b. The weight of the gown dispensing system 1020 may then be supported by the brackets 1034a and 1034b on the personal protection equipment dispenser 1054.

In this example embodiment, the personal protection equipment dispenser 1054 also includes expandable shelves 1058 positioned adjacent the brackets 1034a and 1034b (and adjacent the mounted gown dispensing system 1020). The expandable shelves 1058 are configured to engage and support any suitable container on the support 1056. For example, in the illustrated embodiment the expandable shelves 1058 are shown supporting boxes 1060 containing latex gloves 1060a.

The personal protection equipment dispenser 1054 may be coupled to any desired surface for allowing access to the equipment (e.g., gowns 1002, the gloves 1060a, etc.) on the personal protection equipment dispenser 1054. For example, the personal protection equipment dispenser 1054 may be attached to a wall by employing a U-shaped bracket, a J-hook shaped bracket, a bracket similar to brackets described above, brackets such as those described in U.S. Pat. No. 7,246,710 (which is incorporated herein by reference in its entirety), etc.

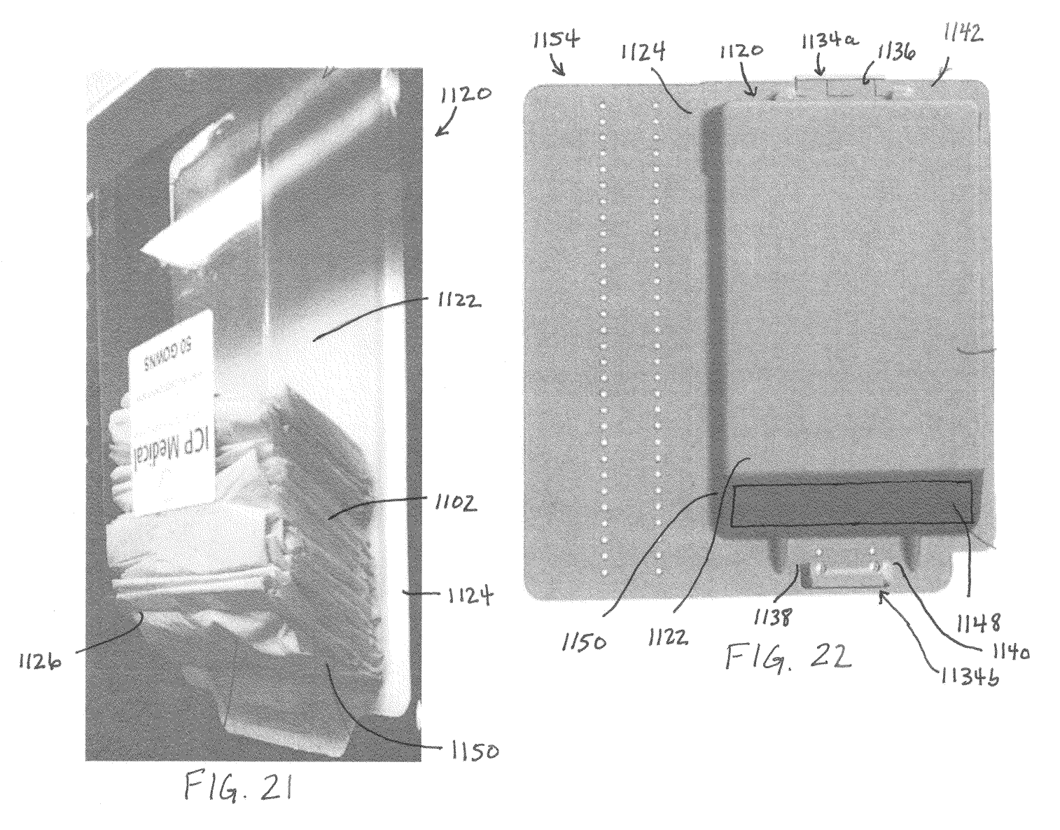

FIGS. 21 and 22 illustrate a gown dispensing system 1120 according to another example embodiment of the present disclosure. The dispensing system 1120 can be used, as desired, to hold and dispense gowns 1102 (e.g., to hold multiple gowns 1102 and allow for dispensing one of the gowns 1102 at a time, etc.). And, for example, the gowns 1102 could be configured in accordance with the example process 100 of the present disclosure.

The gown dispensing system 1120 of this example embodiment is generally similar to the gown dispensing system 920 described in connection with FIGS. 14-18. For example, the gown dispensing system 1120 of this example embodiment generally includes a front member 1122 and a back member 1124 that are configured to be coupled together to define, for example, a gown dispensing fixture, etc. for holding the gowns 1102. And, in the illustrated embodiment, the front member 1122 and the back member 1124 are separately formed and then are joined together after the gowns 1102 are placed therebetween.

In this example embodiment, the front member 1122 of the gown dispensing system 1120 has an angled member 1150 at a bottom of the front member 1122. In particular in this embodiment, the angled member 1150 generally defines the bottom of the front member 112. The angled member 1150 generally extends downwardly (e.g., at a downward angle, etc.) from the front member 1122 to the back member 1124 and is configured to position the gowns 1102 in the gown dispensing system 1120 at a correspondingly downwardly angled position within the system 1120 (e.g., with the gowns 1102 in contact with the angled member 1150 and generally parallel thereto, etc.). The angled member 1150 can be any desired angle (relative to the front member 1122 and/or the back member 1124), and thus allows the distance between the front member 1122 and the back member 1124 (i.e., a depth of the gown dispensing system 1120) to be generally any desired distance. The depth of the gown dispensing system 1120 may be altered by increasing or decreasing an angle of the angled member 1150 relative to the front member 1122 and/or the back member 1124. In other example embodiments, gown dispensing systems may include front members with angled members located toward bottoms of the front members extending generally upwardly from the front members, toward back members of the gown dispensing systems.

Also in this embodiment, the angled member 1150 of the front member 1122 of the gown dispensing system 1120 includes a dispensing opening 1126 configured to facilitate removal of a single gown 1102 at a time by a user from the gown dispensing system 1120. With this positioning of the dispensing opening 1126 (in the angled member 1150 of the front member 1122), a single gown 1102 is visible and available to a user through the dispensing opening 1126. This can assist the user in locating the single gown 1102 for removal. In addition, the dispensing opening 1126 can be formed with any desired shape (e.g., any shape disclosed herein, any other suitable shape, etc.) through which the gowns 1102 can be individually extracted, one by one, for use. And further, the dispensing opening 1126 may be initially closed (e.g., covered, blocked, etc.) by a barrier (e.g., any barrier disclosed herein, any other suitable barrier, etc.) 1148 (FIG. 22) to help inhibit contamination, etc. of the gowns 1102 after they are placed in the gown dispensing system 1120.

FIG. 22 illustrates the gown dispensing system 1120 coupled to a personal protection equipment 1574 dispenser 1154. Upper and lower brackets 1134a and 1134b of the personal protection equipment dispenser 1154 are used to couple the gown dispensing system 1120 to the personal protection equipment dispenser 1154. The brackets 1134a and 1134b may be attached to the personal protection equipment dispenser 1154 by any suitable fasteners (e.g., screws, bolts, etc.), adhesives, other suitable attachment means, etc. The upper bracket 1134a is configured to engage a lip 1142 of the gown dispensing system 1120, and receive the lip 1142 within a groove 1136 of the bracket 1134a. And, the lower bracket 1134b is configured to engage (and be received within) an opening 1138 defined in the back member 1124 of the gown dispensing system 1120. Specifically, a portion of the lower bracket 1134b extending from the personal protection equipment dispenser 1154 is configured to engage and pass through the opening 1138, and receive an edge of the opening 1138 into a slot 1140 of the bracket 1134b. The weight of the gown dispensing system 1120 may then be supported by the brackets 1134a and 1134b on the personal protection equipment dispenser 1154.

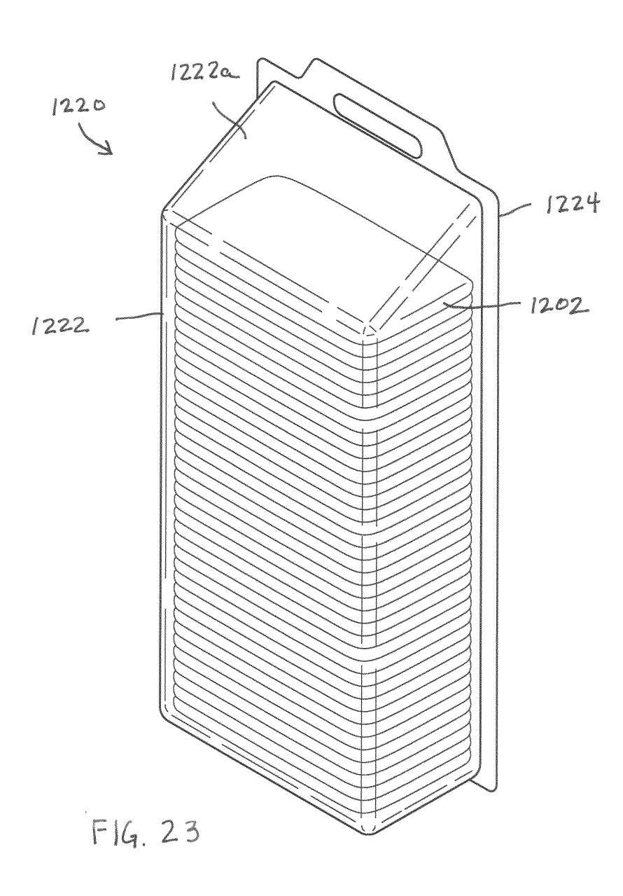

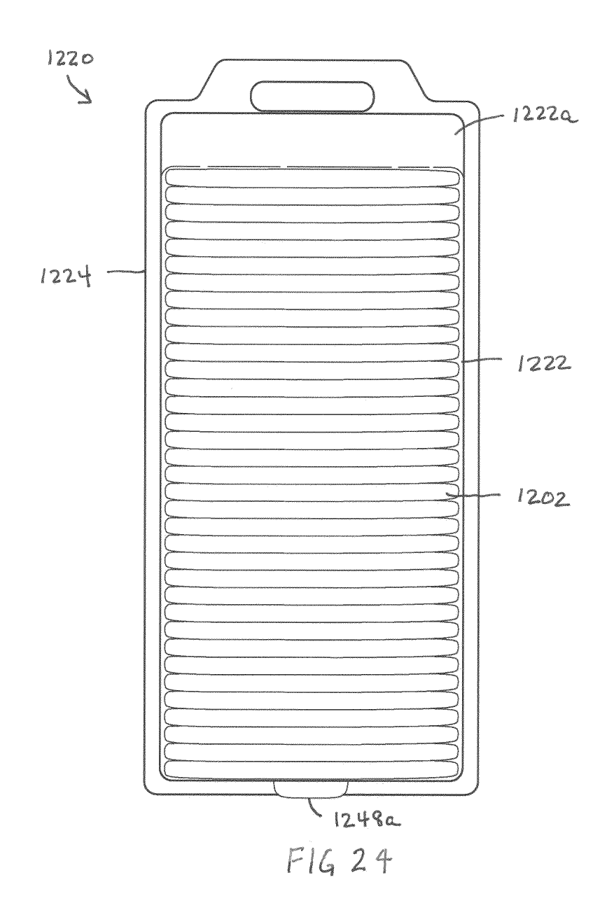

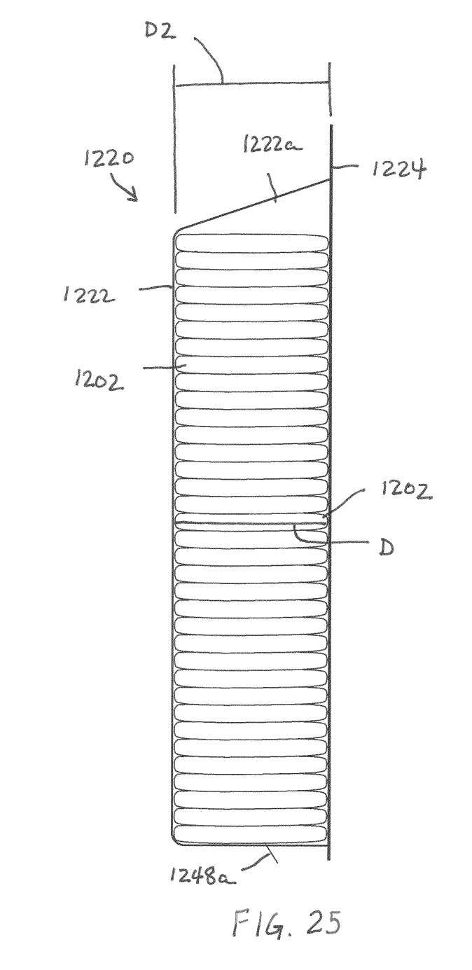

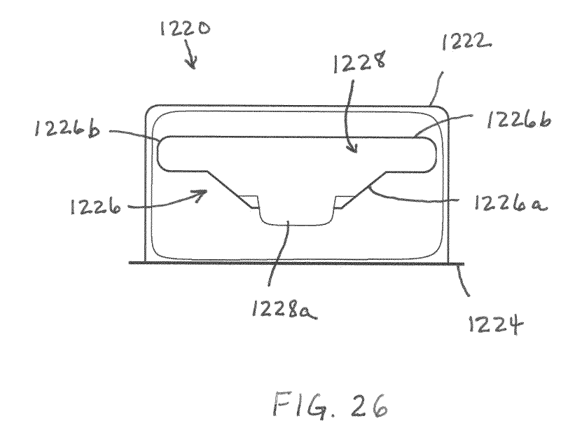

FIGS. 23-26 illustrate a gown dispensing system 1220 according to another example embodiment of the present disclosure. The dispensing system 1220 can be used, as desired, to hold and dispense gowns 1202 (e.g., to hold multiple gowns 1202 and allow for dispensing one of the gowns 1202 at a time, etc.). And, for example, the gowns 1202 could be configured in accordance with the example process 100 of the present disclosure.

The gown dispensing system 1220 includes a front member 1222 and a back member 1224 that are configured to be coupled together to define, for example, a gown dispensing fixture, etc. for holding the gowns 1202. Here, a depth D2 of the gown dispensing system 1220 is about equal to a depth D of the gowns 1202 disposed within the gown dispensing system 1220. And, in the illustrated embodiment, the front member 1222 and the back member 1224 are separately formed and then are joined together after the gowns 1202 are placed therebetween.

A dispensing opening 1226 is defined in a bottom portion of the front member 1224 of the gown dispensing system 1220 and is configured to facilitate removal of a single gown 1202 at a time by a user from the gown dispensing system 1220. With this positioning of the dispensing opening 1226, a single gown 1202 is visible and available to a user through the dispensing opening 1226. This can assist the user in locating the single gown 1202 for removal. In addition, the dispensing opening 1226 can be formed with any desired shape (e.g., any shape disclosed herein, any other suitable shape, etc.) through which the gowns 1202 can be individually extracted, one by one, for use. For example, the illustrated dispensing opening 1226 is formed with a generally trapezoidal center portion 1226a and narrowed slots 1226b extending outwardly from upper portions of the center portion 1226a (which can help ensure removal of one gown 1202 at a time through the dispensing opening 1226). Further, the dispensing opening 1226 is initially closed (e.g., covered, blocked, etc.) by a barrier 1248 (having pull tab 1248a) to help inhibit contamination, etc. of the gowns 1202 after they are placed in the gown dispensing system 1220.

An upper portion 1222a of the front member 1222 of the gown dispensing system 1220 is generally angled, extending generally upwardly (at an angle) from the front member 1222 toward the back member 1224. With this configuration, the upper portion 1222a of the front member 1222 can be used to accommodate a decal, logo, sticker, etc. For example, an angle of the upper portion 1222a relative to the horizontal (e.g., a horizontal plane, etc.), or alternatively, to the vertical, may be any suitable angle to allow an individual, patient, employee, visitor, passerby, etc. to view, access, read, etc. the decal, logo, sticker, etc. The angle of the upper portion 1222a may be, for example, about 30 degrees, about 45 degrees, about 60 degrees, less than about 30 degrees, less than about 45 degrees, less than about 60 degrees, between about 30 and 60 degrees, between about 40 and 50 degrees, etc. And, the decal logo, sticker, etc. may be coupled to the upper portion 1222a in any suitable manner, including by adhesive, pins, rivets, screws, nails, velcro, etc.

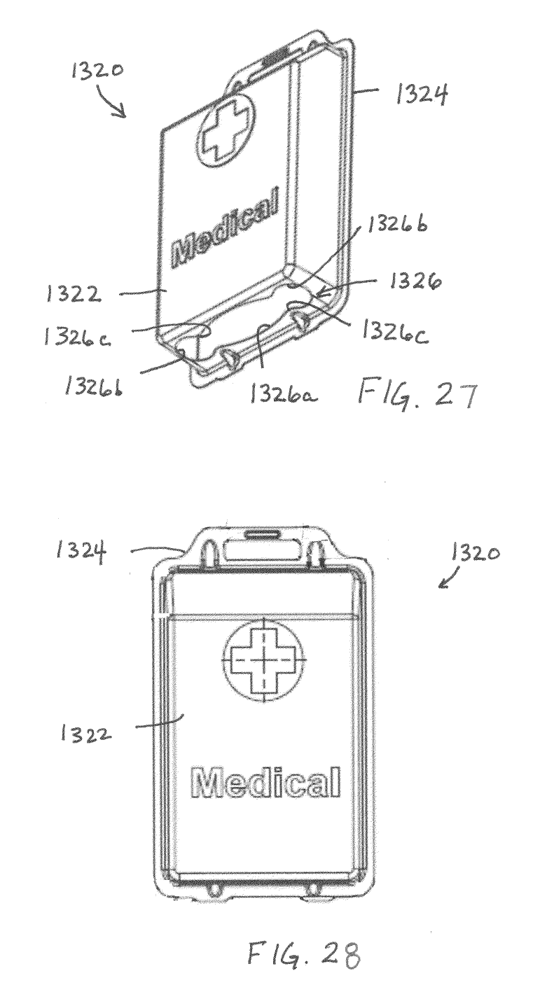

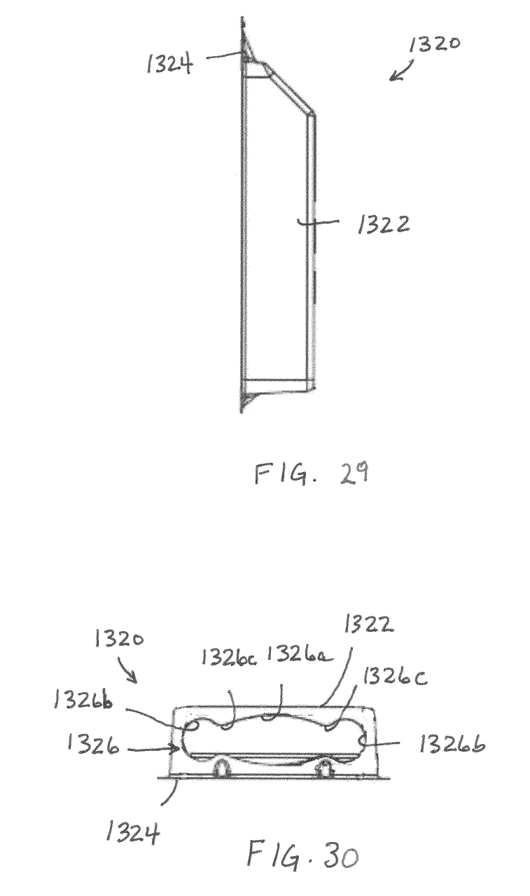

FIGS. 27-30 illustrate a gown dispensing system 1320 according to another example embodiment of the present disclosure. The dispensing system 1320 can again be used, as desired, to hold and dispense gowns (not shown) (e.g., to hold multiple gowns and allow for dispensing one of the gowns at a time, etc.). And, for example, the gowns could be configured in accordance with the example process 100 of the present disclosure.

The gown dispensing system 1320 of this example embodiment is generally similar to the gown dispensing system 1220 described in connection with FIGS. 23-26. For example, the gown dispensing system 1320 of this example embodiment generally includes a front member 1322 and a back member 1324 that are configured to be coupled together to define, for example, a gown dispensing fixture, etc. for holding gowns. And, in the illustrated embodiment, the front member 1322 and the back member 1324 are separately formed and then are joined together after gowns are placed therebetween.

In this example embodiment, however, the gown dispensing system 1320 includes a dispensing opening 1326 configured differently than the dispensing opening 1226 of the gown dispensing system 1220. Here, the dispensing opening 1326 includes a generally oval center portion 1326a and generally circular side portions 1326b, with the circular side portions 1326b connected to the oval portion 1326a by slots 1326c. The generally oval center portion 1326a and the generally circular side portions 1326b are sized to allow a user to access a gown in the gown dispensing system 1320, and the slots 1326c are configured to help ensure that only one gown is removed from the gown dispensing system 1320 at a time. As an example, the generally oval center portion 1326a and/or the generally circular side portions 1326b may have dimensions extending in a depth dimension of the system 1320 of about 2.8 inches, etc.

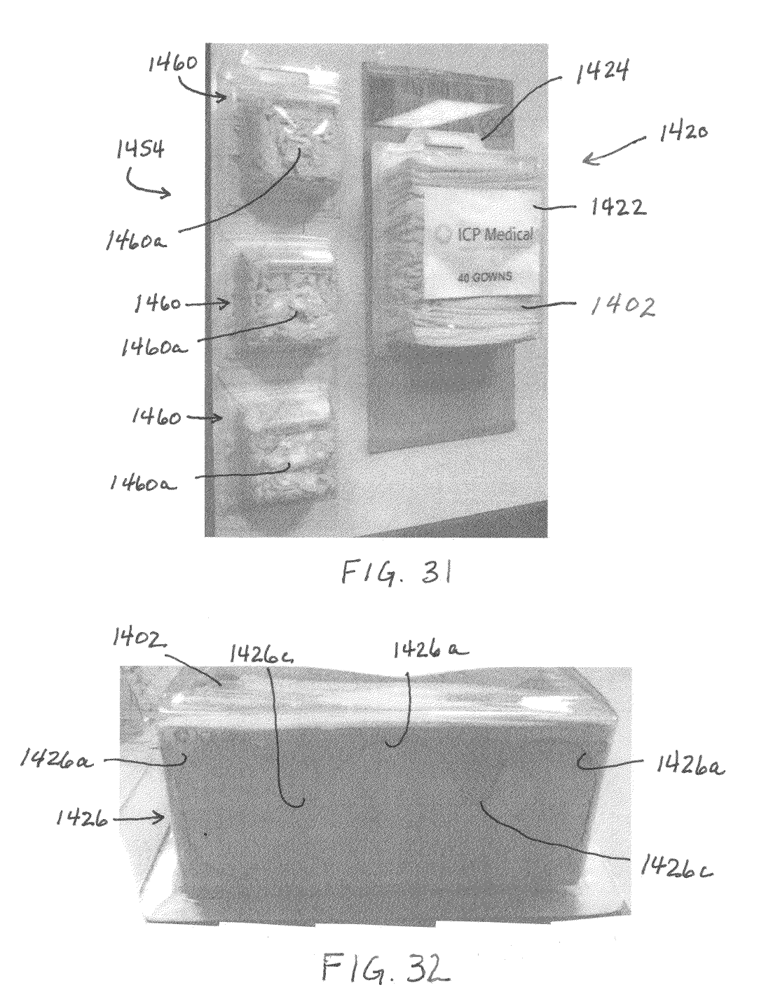

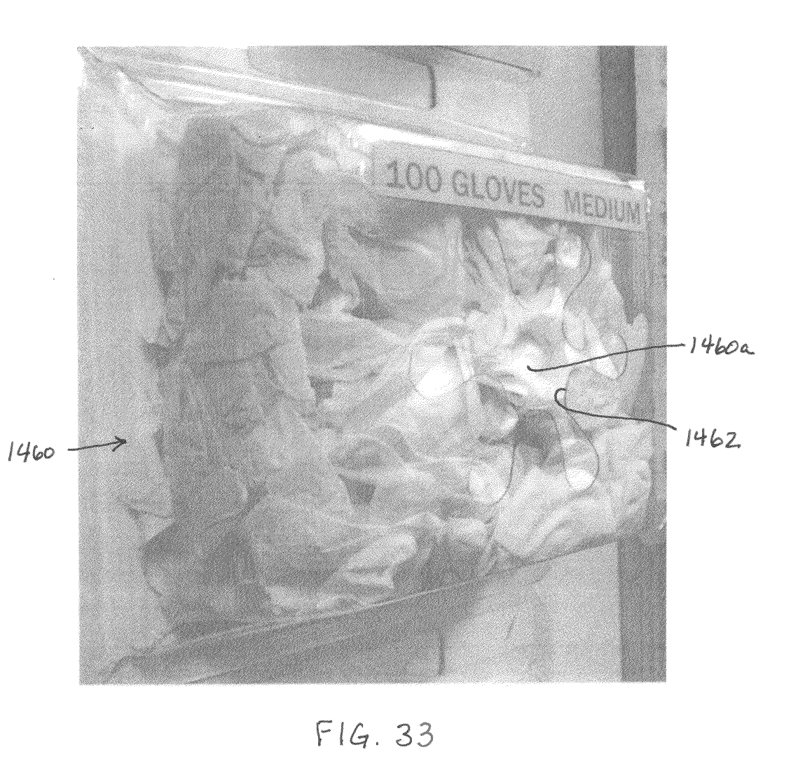

FIGS. 31-33 illustrate an example embodiment of a personal protection equipment (PPE) dispenser 1454 to which a gown dispensing system 1420 is coupled (e.g., via adhesive, etc.). The dispensing system 1420 can be used, as desired, to hold and dispense gowns 1402 (e.g., to hold multiple gowns 1402 and allow for dispensing one of the gowns 1402 at a time, etc.). And, for example, the gowns 1402 could be configured in accordance with the example process 100 of the present disclosure.

The gown dispensing system 1420 generally includes a front member 1422 and a back member 1424 that are configured to be coupled together to define, for example, a gown dispensing fixture, etc. for holding gowns. And, in the illustrated embodiment, the front member 1422 and the back member 1424 are separately formed and then are joined together after gowns are placed therebetween. A dispensing opening 1426 is defined in a bottom portion of the front member 1422. Here, the dispensing opening 1426 includes three generally circular openings 1426a interconnected by slots 1426c. The generally circular openings 1426a are sized to allow a user to access a gown 1402 in the gown dispensing system 1420, and the slots 1426c are configured to help ensure that only one gown 1402 is removed from the gown dispensing system 1420 at a time.

In this example embodiment, the personal protection equipment dispenser 1454 also includes containers 1460 for holding gloves 1460a. The glove containers 1460 include generally star shaped openings 1462 to help facilitate removal of the gloves 1460a from the containers 1460.

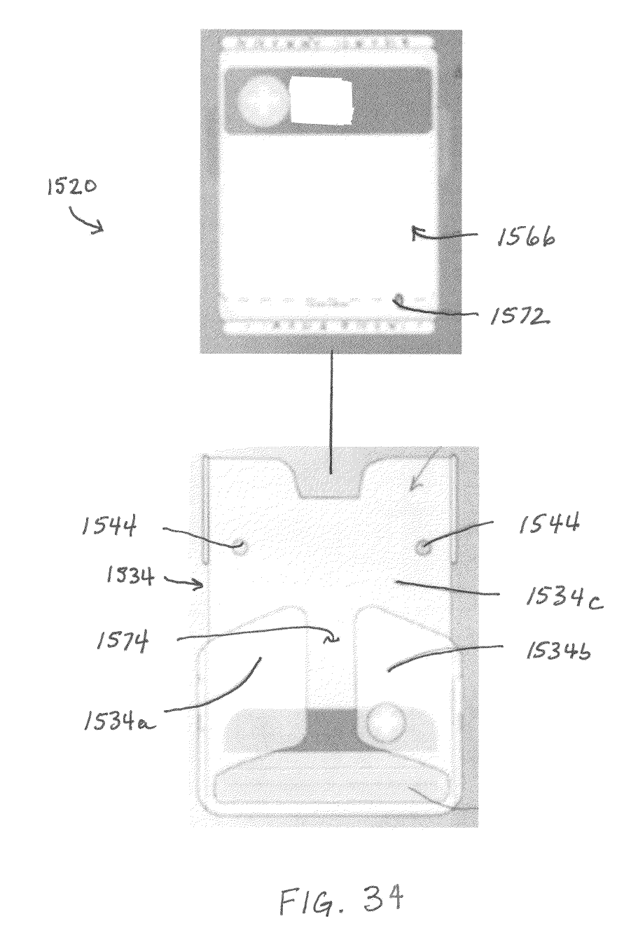

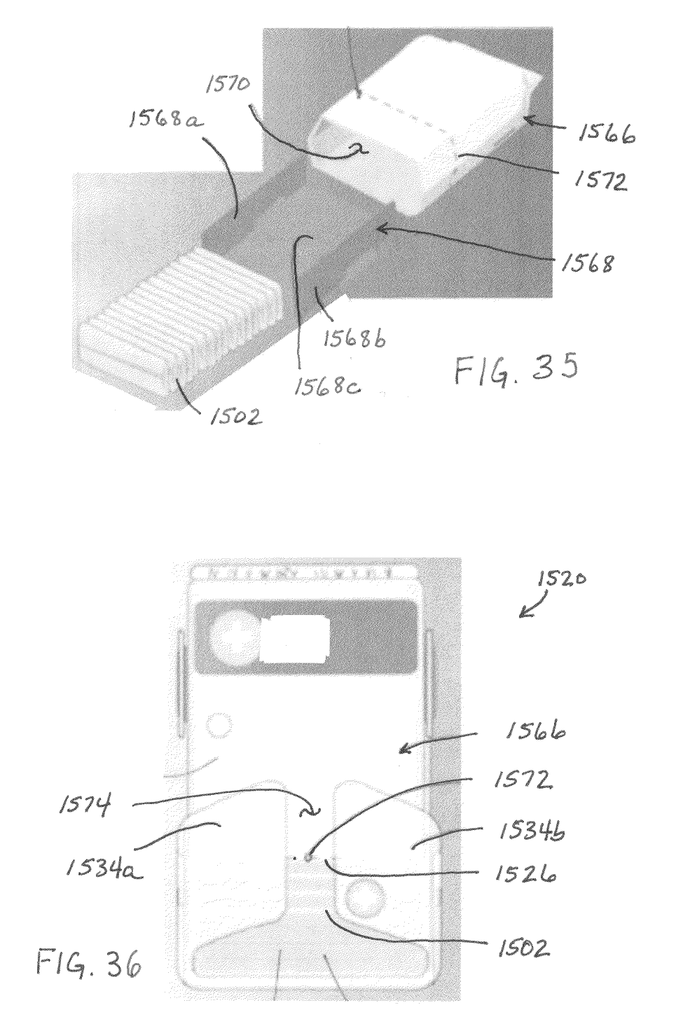

FIGS. 34-36 illustrate a gown dispensing system 1520 according to another example embodiment of the present disclosure. The dispensing system 1520 can be used, as desired, to hold and dispense gowns 1502 (e.g., to hold multiple gowns 1502 and allow for dispensing one of the gowns 1502 at a time, etc.). And, for example, the gowns 1502 could be configured in accordance with the example process 100 of the present disclosure.

The gown dispensing system 1520 generally includes a bag 1566 (broadly, a container), an inner sleeve 1568, and a plurality of the gowns 1502. The inner sleeve 1568 is configured to support the plurality of disposable gowns 1502. The illustrated inner sleeve 1568 includes two outer portions 1568a and 1568b, and an inner portion 1568c positioned between the outer portions 1568a and 1568b. And, the outer portions 1568a and 1568b extend substantially perpendicular from the inner portion 1568c. Alternatively, the outer portions 1568a and 1568b could extend from the inner portion 1568c at any suitable angle that sufficiently supports the plurality of disposable gowns 1502. The bag 1566 can be formed from suitable materials, for example, cloth, plastics, flexible materials, etc. within the scope of the present disclosure.

The inner sleeve 1568 of the gown dispensing system 1520 may be formed of a single piece of material (e.g., cardboard, a corrugated material, or any other suitable material). In this case, the single piece of material may include at least two lines extending the length of the inner sleeve 1568 to allow a user or a machine to fold the outer portions 1568a and 1568b to an appropriate position relative to the inner portion 1568c. The lines may be, for example, perforated lines or any other suitable line that assists in folding the outer portions 1568a and 1568b. The lines may be positioned in the single piece of material by a die-cut process or any other suitable process. Alternatively, the inner sleeve 1568 may be formed by attaching the outer portions 1568a and 1568b to the inner portion 1568c by any suitable attachment means. That is, the outer portions 1568a and 1568b and the inner portion 1568c are separate pieces of material (e.g., cardboard, a corrugated material or any other suitable material). In other example embodiments, inner sleeves of gown dispensing systems may be formed from single pieces of material including more than two lines to allow users or machines to fold the single pieces of material in multiple shapes and configurations.

The bag 1566 of the gown dispensing system 1520 is configured to receive the combination of the inner sleeve 1568 and the plurality of disposable gowns 1502 via an opening 1570 of the bag 1566. Accordingly, the bag 1566 is configured to engage the combination of the inner sleeve 1568 and the plurality of disposable gowns 1502. After the combination of the inner sleeve 1568 and the plurality of disposable gowns 1502 are received by the bag 1566 (or inserted into the bag 1566) via the opening 1570, the bag 1566 may be sealed shut (i.e., enclosed). The bag 1566 (at the opening 1570) may be sealed by vacuum sealing, shrink wrapping or any other suitable method of sealing the bag 1566. An example of the bag 1566 sealed is illustrated in FIG. 34. In the illustrated embodiment, the bag 1566 includes a single opening (i.e., the opening 1570), however in other embodiments, bags may include more than one opening.

The sealed bag 1566 includes a line 1572 extending along a bottom portion of the bag 1566. The line 1572 may be configured to indicate to a user where to cut or tear the bag 1566 for accessing the plurality of disposable gowns 1502. The line 1572 may be a perforated line, a dashed line, a solid line, etc.

The plurality of disposable gowns 1502 are configured to engage the inner sleeve 1568. For example, the plurality of disposable gowns 1502 are positioned between the outer portions 1568a and 1568b while resting on the inner portion 1568c of the inner sleeve 1568. The plurality of disposable gowns 1502 may be positioned at any suitable angle relative to the inner portion 1568c of the inner sleeve 1568. For example, the inner sleeve 1568 may include an angled member (as described in other example embodiments herein) to allow the gowns 1502 to be positioned at a desired angle. That is, the inner sleeve 1568 and the angled member may be a single piece of material and, for example, include lines (e.g., perforated lines or any other suitable line) that assist in folding the angled member. Alternatively, the inner sleeve 1568 and the angled member may be separate pieces attached together to form a desired angle. In other embodiments, ribs may be provided along sides of the inner sleeve 1568 to hold the gowns 1502 at a desired angle, for example any one of the angles described above. Alternatively, any other suitable feature (e.g., a structure, etc.) may be employed to hold the gowns 1502 at a desired angle, for example any one of the angles described above.

The gown dispensing system 1520 includes a bracket 1534 configured to support the bag 1566. The bracket 1534 includes a back portion 1534c and flanges 1534a and 1534b (e.g., one or more flanges, etc.) extending from the back portion 1534c. The bracket 1534 (including the back portion 1534c and the flanges 1534a and 1534b) may be formed of a single piece of material (e.g., plastic or any other suitable material). Or alternatively, the bracket 1534 may be formed of separate and discrete pieces. That is, the back portion 1534c and the flanges 1534a and 1534b may be coupled together to form the bracket 1534.

The flanges 1534a and 1534b of the bracket 1534 extend substantially perpendicular from the back portion 1534c for a distance. The flanges 1534a and 1534b then extend inwardly toward each other (i.e., each flange 1534a and 1534b extends toward the opposing other flange 1534a and 1534b). The flanges 1534a and 1534b extend toward each other for an appropriate distance to maintain an opening, spacing, etc. (identified at reference number 1574) between a free end portion of each flange. The flanges 1534a and 1534b and the back portion 1534c are further arranged to create a space between the flanges 1534a and 1534b and the back portion 1534c configured to receive the bag 1566. The bag 1566 can be inserted within the space between the flanges 1534a and 1534b and the back portion 1534c. The bag 1566 then may rest between the flanges 1534a and 1534b and the back portion 1534c (as shown in FIG. 36). In the illustrated embodiment, the space between the flanges 1534a and 1534b and the back portion 1534c has a dimension that is less than that of the bag 1566 such that the flanges operate to generally frictionally hold the bag 1566 therebetween (and in conjunction with the back portion 1534c). Alternatively, the flanges 1534a and 1534b may include a single flange and may be, for example, coupled to the back portion 1534c at one or more points. Further, the flanges 1534a and 1534b may include structure configured to engage and hold the bag 1566 in the bracket 1534.

The back portion 1534c of the bracket 1534 also includes holes 1544 (e.g., one or more holes, etc.) to attach the bracket 1534 to a wall, a support, a personal protection equipment (PPE) dispenser, etc. Alternatively, an adhesive or any other suitable material or structure may be employed to attach the bracket 1534 to the wall, the support, the PPE dispenser, etc.

With reference to FIG. 36, the bag 1566 of the gown dispensing system 1520 (after installation to the bracket 1534) can be opened near the bottom portion of the bag 1566 (e.g., at an access location such as, for example, the line 1572, etc.) to expose the multiple gowns 1502 therein. After opening the bag 1566, a dispensing opening 1526 is formed in the bag 1566. The dispensing opening 1526 can be configured in a shape to allow individual ones of the gowns 1502 to be extracted at a time. Alternatively, the dispensing opening 1526 could be configured to allow the entire bag 1566 to be removed from the bracket 1534 while allowing the gowns 1502 to remain in the space between the flanges 1534a and 1534b and the back portion 1534c of the bracket 1534 (e.g., to slide out of the bag and remain in the bracket 1534, etc.). In this way, the bracket 1534 of the gown dispensing system 1520 can be refilled with gowns 1502 by then inserting an another bag 1566 of gowns into the bracket 1534, with the prior remaining gowns 1502 still in the bracket, thereby allowing the prior remaining gowns 1502 to be used.

In other example embodiments, depths of gown dispensing systems may have substantially the same depths as folded gowns to be retained within the systems. In other example embodiments, gown dispensing systems may have depths greater than depths of folded gowns to be retained within the systems. In one example embodiment, a gown dispensing system has a depth that is about one inch greater than a depth of a folded gown to be retained in the system. In another example embodiment, a gown dispensing system has a depth that is about 0.5 inches greater than a depth of a folded gown to be retained in the system. In still another example embodiment, a gown dispensing system has a depth that is about 0.25 inches greater than a depth of a folded gown to be retained in the system. And in still another example embodiment, a gown dispensing system has a depth that is between about 0.1 inches and about 0.25 inches greater than a depth of a folded gown to be retained in the system. In other example embodiments, depths of gown dispensing systems may be less than depths of folded gowns to be retained within the systems.

In one example embodiment, a gown dispensing system generally includes a height dimension of about twenty-two inches, a width dimension of about thirteen inches, and a depth dimension of about four inches.

With that said, specific dimensions included herein are exemplary in nature and do not limit the scope of the present disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A dispensing system for dispensing gowns, the dispensing system comprising:
folded gowns each comprising a folding pattern, the folding pattern of each gown configured to provide a user access to a neck and shoulder portion of the gown after unfolding a single fold of the folded the gown; and
a front member and a back member defining an enclosure for holding the gowns, the front member comprising an opening formed therein and configured to facilitate removal of a single gown at a time from the enclosure through the opening by the user.

2. The dispensing system of claim 1, wherein the opening of the front member includes a generally circular center portion and slots extending from opposing sides of the generally circular center portion, and wherein a generally vertical dimension of the generally circular center portion is greater than a generally vertical dimension of the slots, whereby the generally circular center portion allows for access to the gowns through the opening while the slots restrict extraction through the opening to a single gown at a time.

3. The dispensing system of claim 2, wherein the generally circular center portion of the opening includes resiliently flexible fingers disposed at least partly around the generally circular center portion.

4. The dispensing system of claim 1, wherein the gowns are disposed in the in the enclosure defined by the front member and the back member such that a forward fold of each gown is generally oriented toward the front member and a folded top portion of each gown is generally facing upwardly.

5. The dispensing system of claim 1, wherein the front member includes multiple strengthening ribs.

6. The dispensing system of claim 1, further comprising at least one bracket for use in coupling the front and back members to a desired surface, wherein the at least one bracket is configured to couple to the back member at a lip formed by the front and/or back members.

7. The dispensing system of claim 1, further comprising at least one bracket for use in coupling the front and back members to a desired surface, wherein the at least one bracket is configured to couple to the back member at an opening formed in the back member.

8. A method for folding a gown for use in a gown dispensing system, the method comprising:
folding a left arm portion over a back of the gown;
folding a left portion of the gown, comprising about a third of the gown, across a center portion of the back of the gown, with a left tie of the gown extending onto a right arm portion of the gown;
folding the left tie back onto the center portion of the gown;
folding the right arm portion over the back of the gown;
folding a right tie and a portion of the gown that extends downward from the right tie towards the center portion of the gown;
folding a right portion of the gown, comprising about a third of the gown, over the center potion, resulting in a substantially rectangular shape for the partially folded gown;
folding over a bottom of the gown an amount equal to about twice the final folded depth of the gown to define a folded bottom portion of the gown;
folding the folded bottom portion of the gown in half, and then further folding the folded bottom portion of the gown over itself two times;
folding over a top of the gown an amount equal to about the final folded depth of the gown to define a folded top portion of the gown; and
folding the folded top portion of the gown over the folded bottom portion of the gown.

9. A dispensing system for dispensing gowns, the dispensing system comprising:
a front member and a back member defining an enclosure for holding gowns, the front member comprising an opening formed therein and configured to facilitate removal of a single gown at a time from the enclosure through the opening by a user; and
an angled portion configured to support the gowns in the enclosure at an angle relative to a horizontal plane when the gown dispensing system is coupled to a vertical surface.

10. The dispensing system of claim 9, wherein a depth dimension of the enclosure defined by the front member and the back member is less than a depth dimension of a folded gown disposed within the enclosure.

11. The dispensing system of claim 10, wherein the depth of the enclosure is about 4.5 inches or less.

12. The dispensing system of claim 9, wherein the angled portion is formed as part of the front member.

13. The dispensing system of claim 12, wherein the angled portion is formed as a bottom of the front member, and wherein the angled portion further includes the opening formed in the front member for allowing removal of the gowns from the enclosure.

14. The dispensing system of claim 9, further comprising the gowns, wherein each gown comprises a folding pattern configured to provide a user access to a neck and shoulder portion of the gown after unfolding a single fold of the folded the gown.

15. The dispensing system of claim 14, wherein a depth dimension of the enclosure defined by the front member and the back member is less than a depth dimension of each of the gowns disposed within the enclosure.

16. The dispensing system of claim 9, further comprising a bracket for use in coupling the front and back members to a desired surface, wherein the bracket is configured to couple to the back member at a lip formed by the front and/or back members.

17. A personal protection equipment (PPE) dispenser including the gown dispensing system of claim 9.

18. A dispensing system for dispensing gowns, the dispensing system comprising:
a container configured to hold multiple folded gowns, the container including an access location for selectively opening the container so that individual ones of the gowns may be extracted from the container; and
a bracket having flanges configured to receive the container into the bracket between the flanges;
wherein the bracket is configured to hold the container between the flanges such that the access location is accessible to a user for selectively opening the container to allow for extraction of the gowns from the container, and wherein the bracket is configured to allow for removal of the container from the bracket while retaining the folded gowns in the bracket as they slide out of the container at the access location as the container is removed from the bracket.

19. The dispensing system of claim 18, wherein the container includes a generally rigid inner portion for holding the folded gowns in the container.

20. The dispensing system of claim 18, wherein the container comprises a flexible bag.

21. The gown dispensing system of claim 18, further comprising the multiple folded gowns configured to be held in the container, wherein each gown comprises a folding pattern configured to provide a user access to a neck and shoulder portion of the gown after unfolding a single fold of the folded the gown.
